(19) United States
(12) Patent Application Publication
(10) Pub. No.: US 2026/0231109 A1
(43) Pub. Date: Aug. 6, 2026

(54) METHODS, ARCHITECTURES, APPARATUSES, AND SYSTEMS FOR SENSING TARGET DETECTION

(71) Applicant: InterDigital Patent Holdings, Inc., Wilmington, DE (US)

(72) Inventors: Remun Koirala, London (GB); Fumihiro Hasegawa, Westmount (CA); Ghyslain Pelletier, Montreal (CA); Paul Marinier, Brossard (CA); Arman Shojaeifard, London (GB); Tao Deng, New York, NY (US); Kevin Wanuga, Souderton, PA (US)

(21) Appl. No.: 19/044,392

(22) Filed: Feb. 3, 2025

(51) Int. Cl. H04W 64/00; H04L 5/00; H04W 24/08

(52) U.S. Cl. CPC H04W 64/006; H04L 5/0048; H04W 24/08

(57) ABSTRACT

A method is performed by a wireless transmit/receive unit (WTRU) for detecting a target object (TO). The method includes receiving configuration information that includes a TO path profile, an environmental object (EO) path profile, and a confidence indicator. The WTRU receives reference signals and performs path measurements to identify candidate object paths. Based on the TO path profile, EO path profile, and confidence indicator, the WTRU determines a TO path and at least one false alarm path. The WTRU then transmits information about the path measurements associated with the TO path or the false alarm path to a wireless network. The method includes using thresholds for confidence indicators and false alarm probabilities, and may involve downlink positioning reference signal (DL-PRS) configurations. Path measurements can include various metrics such as reference signal received power, delay, angle of arrival, and doppler shift.

### TECHNICAL FIELD

The present disclosure is generally directed to the fields of communications, software and encoding/decoding, including, for example, to methods, architectures, apparatuses, systems related to management of sensing task(s) and detection of sensing target(s).

### BACKGROUND

Sensing involves using radio frequency (RF) signals to detect, estimate, and monitor environmental conditions and objects, such as shape, size, speed, and location. Sensing modes include monostatic (e.g., co-located transmitter and receiver) and bistatic (e.g., non-co-located transmitter and receiver), with multi-static involving multiple transmitters and/or receivers. Use cases, 5G system enhancements, sensing modes, key performance indicators (KPIs), and channel modeling were studied. However, sensing tasks are not fully developed.

### SUMMARY

In certain representative embodiments, a method is performed by a wireless transmit/receive unit (WTRU) for detecting a target object (TO). The method comprises receiving configuration information that includes a TO path profile, an environmental object (EO) path profile, and a confidence indicator. The WTRU receives reference signals and performs path measurements to identify candidate object paths. Based on the TO path profile, EO path profile, and confidence indicator, the WTRU determines a TO path and at least one false alarm path. The WTRU then transmits information about the path measurements associated with the TO path or the false alarm path to a wireless network.

In some embodiments, the method comprises using thresholds for confidence indicators and false alarm probabilities, and may involve reference signal configurations. For example, path measurements include various metrics such as reference signal received power, delay, angle of arrival, doppler shift, among others.

A system includes a WTRU with a processor and transceiver to perform the above-referenced functions.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2A depicts an example of a system including a WTRU for path measurement, a first object, a second object, and a transmission reception point (TRP), according to one or more embodiments;

FIG. 2B is a chart of reference signal received power per path (RSRPP) versus relative delay for various paths shown in FIG. 2A, according to one or more embodiments;

FIG. 2C is a chart of RSRPP versus angle of arrival (AoA) for various paths shown in FIG. 2A, according to one or more embodiments;

FIG. 3 depicts an example of a procedure for initiation of a detection procedure, according to one or more embodiments;

FIG. 4 depicts an example of an association of a reference signal with an area, according to one or more embodiments;

FIG. 5 depicts an example of a procedure for a configuration request from a WTRU, according to one or more embodiments;

FIG. 6 depicts an example of a system including a WTRU and a TRP including sensing range association with subcarrier spacing, according to one or more embodiments;

FIG. 7A is a chart of RSRPP versus relative delay profiles for various paths shown in FIG. 7B, according to one or more embodiments;

FIG. 7B depicts an example of a system including a WTRU, an EO, a sensing target, and a TRP including paths therebetween, according to one or more embodiments;

FIG. 8 is a chart of probability versus measurement profiles for a target and an EO, according to one or more embodiments;

FIG. 9 depicts an example of a procedure for a WTRU requesting a (e.g., second) configuration for target detection, according to one or more embodiments; and

FIG. 10 is a flow chart of an example of sensing target detection, according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

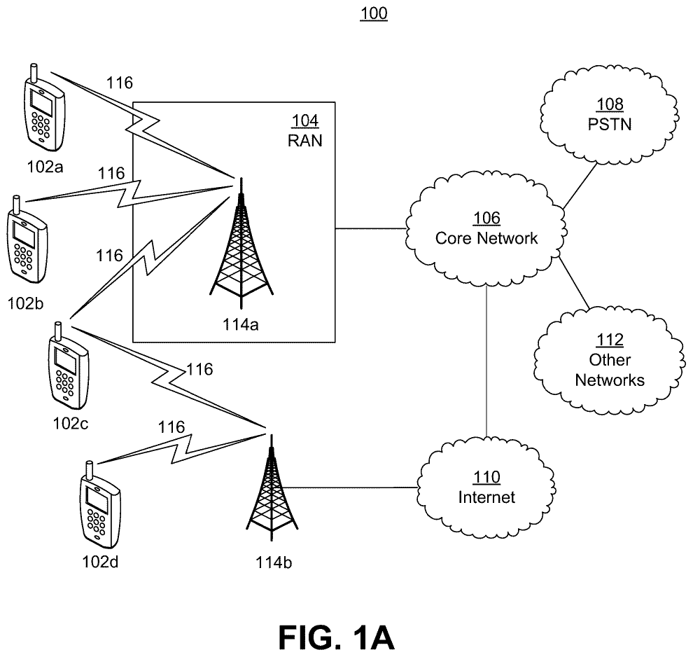

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA,” may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

It will be understood that a wireless network may include any suitable components and devices, including, for example, any of one or more base stations, one or more transmission reception points (TRPs), one or more gNBs, one or more WTRUs, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). The frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, or the like) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, or the like, and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), or the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of the elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, or the like.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of the component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of the elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In certain representative embodiments, methods are provided for sensing target detection. For example, sensing target detection is provided for NR Integrated Sensing and Communications (ISAC). Also, for example, at least one of target detection, false alarm probability determination, missed detection probability determination, or reporting is provided. Further, for example, a WTRU receives a configuration (e.g., downlink positioning reference signal (DL-PRS) configuration) for detection of a target (e.g., target object (TO)). In addition, for example, the configuration for detection of the target includes a TO path profile, an environmental object (EO) path profile, and a confidence indicator (e.g., a false alarm threshold). Moreover, for example, based on a measurement, the WTRU detects a sensing path. Furthermore, for example, the WTRU determines a probability of a false alarm for each detected path. Additionally, for example, the WTRU reports one or more detected path measurements based on determination of a false alarm.

In certain representative embodiments, at least one of sensing, infrastructure for sensing, or sensing target detection is provided. For example, sensing is network-based, WTRU-assisted, or WTRU-based. Also, for example, the types of sensing differ in terms of what role each node in a sensing infrastructure is performing (e.g., TRP, WTRU, core network (e.g., sensing management function (SMF), location management function (LMF), other higher layer entities (e.g., applications) or the like). Further, for example, sensing information includes one or more measurements, location information of one or more TOs, velocity information of the one or more TOs, or the like. In addition, for example, target detection is a process of identifying a presence of a sensing target. Moreover, for example, an identification step of target detection includes determining whether a target is present or not. Furthermore, for example, a probability of a false alarm, e.g., falsely detecting a presence of a target or an EO when the target or EO is not present, is determined. Additionally, for example, a probability of a missed detection, e.g., not detecting a presence of a target or an EO when the target or EO is present, is determined.

In certain representative embodiments, 3GPP for New Radio (NR) is provided with one or more functionalities and/or support dedicated to sensing. For example, one or more features for NR positioning are provided. Also, for example, the one or more features for NR positioning include DL/UL reference signals, architecture, protocols, or the like. Further, for example, one or more sensing features are provided based on one or more NR positioning features. In addition, for example, a target is detected when a timing and a location of the target are otherwise unknown. Moreover, for example, a target is detected in a presence of one or more EOs. Furthermore, for example, a target is detected and differentiated from the presence of one or more EOs so as to avoid a false alarm or a false positive. Additionally, for example, a target is detected and differentiated from the presence of one or more EOs when there is an overlap (e.g., of measurements) between the target and the EO so as to avoid detection error. Still further, for example, a WTRU is configured to detect and isolate one or more sensing targets in a presence of one or more EOs.

In certain representative embodiments, a WTRU, based on assistance information (e.g., target and EO measurement profiles), determines whether a detected path is a target path or an EO path. For example, the WTRU reports a detected path based on a determined false alarm probability. Also, for example, the WTRU receives a DL-PRS configuration for detection of a target. Further, for example, the DL-PRS configuration includes a target path profile, an EO path profile, and a false alarm threshold. In addition, for example, the DL-PRS configuration indicates to the WTRU to determine and report a false alarm probability of the detected target. Moreover, for example, each of the target path profile and the EO path profile comprises at least one statistic (e.g., mean, variance, or the like) associated with a reference target and one or more EO measurement values (e.g., reference signal received power per path (RSRPP), relative delay, doppler shift, or the like). Furthermore, for example, the WTRU receives the DL-PRS resources (e.g., beam sweeping) based on the configured DL-PRS and performs path measurements (e.g., RSRPP, relative delay, doppler shift, or the like). Additionally, for example, the WTRU determines a path measurement as a detected path if a difference between at least one path measurement and a corresponding measurement value (e.g., mean) in a target path profile is below a threshold. Still further, for example, the WTRU determines a probability of false alarm for each detected path based on a measurement for the detected path and a corresponding EO measurement value (e.g., mean, variance, or the like) in the EO path profile. Even further, the WTRU reports information to the network if the determined false alarm probability of a detected path is below the false alarm threshold. Yet further, for example, the reported information includes at least one of measurements associated with the detected path, the determined false alarm probability of the detected path, or the like.

For example, the WTRU is configured to distinguish between a sensing target and an EO when one or more corresponding measurements are not well separated. Also, for example, based on distinguishing between the sensing target and the EO, the WTRU is configured to determine when to report a detected path as a sensing target. Further, for example, the WTRU is configured to report a sensing quality metric (e.g., probability of false alarm and/or missed detection) associated with one or more measurements in a false alarm scenario and one or more missed detection probabilities. In addition, for example, the WTRU is configured to request a new configuration based on a sensing quality metric.

Throughout the present disclosure, the following terminology may be used. The following definitions generally apply unless noted otherwise or implied otherwise by context.

In this disclosure, a “TRP” may be used interchangeably with “gNB” or positioning reference unit (“PRU”) or “sensing transmitter” or a “WTRU.” The term “TRP” may be used to indicate an entity (e.g., RAN entity) capable of transmitting a reference signal (e.g., DL-PRS, synchronization signal block (SSB), channel state information reference signal (CSI-RS), or the like).

A “WTRU” may be used interchangeably with “sensing receiver” and may be used to indicate an entity (e.g., RAN entity) capable of receiving and measuring a reference signal (e.g., DL-PRS, SSB, CSI-RS, or the like).

A “network” may refer to the access mobility function (AMF), LMF, gNB, Next Generation (NG) RAN, or any other entity involved in sensing functionalities (e.g., SMF). An LMF is a non-limiting example of a node or entity (e.g., network node or entity) that may be used for or to support positioning and/or sensing. Any other node or entity (e.g., server, WTRU, SMF, or the like) may be substituted for LMF and still be consistent with this disclosure.

A “reference signal (RS)” may refer to any positioning and/or reference signals, e.g., DL-PRS, sounding reference signal for positioning (SRSp), CSI-RS, demodulation reference signal (DM-RS), SSB, or the like.

A “DL-PRS” may refer to any of the downlink positioning reference signals or any other reference signals that may be received and/or measured by the WTRU, e.g., SSB, CSI-RS, or the like.

A “location” may be used interchangeably with “position.” A location (e.g., WTRU location, TRP location, or the like) may be expressed in terms of altitude, latitude, geographic coordinate, or local coordinate, for example.

An “ID” may be used interchangeably with “index.”

A “path” may be used interchangeably with “multipath.”

The WTRU may receive one or more configurations (e.g., downlink reference signal (DL-RS) configurations, measurement configurations, reporting configurations, or the like) and/or indications/requests (e.g., power indication, beam indication, configuration, activation, deactivation, switching command, or the like) and/or preconfigured and/or configured (hereinafter, “(pre)configured”) thresholds from the network (e.g., LMF, gNB, or the like) via downlink physical channel (e.g., physical downlink shared channel (PDSCH), physical downlink control channel (PDCCH), or the like) or via lower or higher layer signaling (e.g., downlink control information (DCI), medium access control control element (MAC-CE), radio resource control (RRC) or long-term evolution (LTE) positioning protocol (LPP) message, or the like).

The WTRU may send the measurement report (e.g., containing the measurements), indications (e.g., request), or the like to the network (e.g., LMF, gNB, or the like) via a semi-static (e.g., LPP, RRC, or the like) or dynamic message (e.g., uplink control information (UCI), MAC-CE, or the like) or via uplink channel (e.g., physical uplink control channel (PUCCH), physical uplink shared channel (PUSCH), or the like).

Dependency of a first parameter with a second parameter may be interpreted as the first parameter may be a first value if the second parameter is above a (pre)configured threshold, and a second value otherwise.

Measurements may refer to at least one or a combination of the following: reference signal received power (RSRP), RSRPP, delay, relative delay, angle of arrival (AoA), doppler shift, delay spread, doppler spread, reference signal time difference (RSTD), WTRU reception-transmission (Rx-Tx) time difference, reference signal carrier phase (RSCP) measurement (e.g., per path), reference signal (e.g., carrier) phase difference (RSCPD) measurement (e.g., per path), radar cross section (RCS), micro-doppler measurement, or the like. In one example, the measurements may be performed on one or more RSs, and/or associated with one or more path(s) and/or associated with one or more TRPs and/or WTRUs.

A sensing target may alternatively refer to at least one of the EO, scattering point, any one or more elements in the channel that may cause a multipath reflection, or the like.

Detection and sensing may be used interchangeably. In this disclosure, detection may refer to at least one or a combination of one or more procedures related to sensing (e.g., tracking, monitoring, or the like). The procedures defined for target detection may be applicable to any procedures related to sensing.

Time duration units may be in terms of at least one of the following: seconds, number of slots, number of symbols, number of frames and/or number of sub-frames, or the like.

Time index units may be in terms of at least one of the following: absolute time in terms of, e.g., symbol index, slot index, frame index, subframe index, or a relative time in terms of, e.g., number of symbols, number of slots, number of frames, or number of subframes with respect to a reference time, or the like.

Angle units may be in terms of at least one of the following: degrees, radians, or the like.

Distance units may be in terms meters.

Frequency range units may be in terms of at least one of the following: Hertz (Hz), number of resource elements (REs), number of resource blocks (RBs), bandwidth part (BWP), physical frequency layer (PFL), or the like.

Frequency index units may be in terms of at least one of the following: Hz, RE index, RB index, PFL ID, BWP ID, or the like.

DL-PRS configuration may be used interchangeably with measurement configuration and/or reporting configuration.

DL-PRS ID may be used interchangeably with the associated DL-PRS resource ID, DL-PRS beam ID, DL-PRS resource ID, DL-PRS resource set ID, TRP ID, cell ID, Sidelink (SL)-PRS ID, SL-PRS resource ID, SL-PRS resource set ID, or the like.

Sensing delay range may be defined as the total delay duration corresponding to the distance between the sensing transmitter, sensing target, and the sensing receiver, such that the WTRU can receive and measure a signal with at least one measurement above a certain (pre)configured threshold. The sensing delay range may be indicated to be reported in terms of at least one time duration unit.

Sensing angular range may be defined as the range of angle measurements (e.g., angle of departure (AoD) or AoA) where a sensing transmitter may be transmitting and/or a sensing receiver may be receiving and measuring a signal such that at least one measurement is above a (pre)configured threshold. The sensing angle range may be indicated to be reported in terms of at least one of the angle units.

Comparison of a measurement to a corresponding measurement may refer to the procedure of comparing a measurement (e.g., angle measurement) associated with at least one path, frequency component (e.g., RE index), reference signal (e.g., DL-PRS beam ID), TRP (e.g., TRP ID), cell (e.g., cell ID) or the like to the same measurement (e.g., angle measurement) corresponding to at least one of the same associated path, frequency component, reference signal and/or TRP performed in a different occasion or indicated by the network.

An area (e.g., detection area, target sensing service area, EO sensing service area, or the like) may be defined as a region and may be defined in terms of at least one of the following: a coarse location, a zone ID, any other representation of a geographical area, or the like. For example, the coarse location may be defined by an ellipsoid point (e.g., defined by latitude degree, longitude degree and/or latitude sign, or the like) or a geographical location (e.g., 2D location, 3D location, or the like) and may additionally comprise an uncertainty region (e.g., circle, sphere, ellipse, ellipsoid, or the like). Also, for example, zone ID may be defined with reference to a geographical reference (e.g., (0, 0)) and may refer to a geographical area (e.g., square area of zone length L, or the like) defined by a point and the length of the square. In one example, for a given zone length L (e.g., configured by the network), the WTRU may be able to determine the area based on the ID and based on a mathematical mapping equation or a table. Further, for example, any other representation of a geographical area includes, e.g., a set of points (e.g., a convex hull around a point), a location representing a center of a shape (e.g., a rectangle) and the associated parameters, or the like.

In certain representative embodiments, a configuration of RS is provided. For example, the configuration of the RS includes at least one of a configuration for DL-PRS, one or more configurations for SRS for positioning, or the like.

In one example, a PRS configuration may contain at least one of the following parameters: number of symbols, transmission power, number of PRS resources included in PRS resource set, muting pattern for PRS (e.g., the muting pattern may be expressed via a bitmap), periodicity, type of PRS (e.g., periodic, semi-persistent, or aperiodic), slot offset for periodic transmission for PRS, vertical shift of PRS pattern in the frequency domain, time gap during repetition, repetition factor, RE (resource element) offset, comb pattern, comb size, spatial relation, quasi-co location (QCL) information (e.g., QCL target, QCL source) for PRS, number of PRUs, number of TRPs, Absolute Radio-Frequency Channel Number (ARFCN), subcarrier spacing, expected RSTD, uncertainty in expected RSTD, start Physical Resource Block (PRB), bandwidth, BWP ID, number of frequency layers, start/end time for PRS transmission, on/off indicator for PRS, TRP ID, PRS ID, cell ID, global cell ID, PRU ID, applicable time window, or the like. The WTRU may apply a PRS configuration under a condition that the current time is within the applicable time window. “ID” may be used interchangeably with “index.” The WTRU may receive beam width of a PRS or boresight direction (e.g., AoD) of PRS from the network. The configuration described herein is not limited to PRS. It can be applicable to any DL-RS.

In one example, SRS for positioning (SRSp) or SRS configuration may include at least one of: resource ID; comb offset values, cyclic shift values; start position in the frequency domain; number of SRSp symbols; shift in the frequency domain for SRSp; frequency hopping pattern; type of SRSp (e.g., aperiodic, semi-persistent, or periodic); sequence ID used to generate SRSp, or other IDs used to generate SRSp sequence; spatial relation information, indicating which reference signal (e.g., DL-RS, UL RS, CSI-RS, SRS, DM-RS, or the like) or SSB (e.g., SSB ID, cell ID of the SSB, or the like) the SRSp is related to spatially where the SRSp and DL-RS may be aligned spatially; QCL information (e.g., a QCL relationship between SRSp and other reference signals or SSB, or the like); QCL type (e.g., QCL type A, QCL type B, QCL type D, or the like); resource set ID; list of SRSp resources in the resource set; transmission power related information; bandwidth (e.g., expressed in terms of MHz, number of RBs, or the like) or frequency information (e.g., center frequency, ARFCN, frequency layer ID, component carrier ID, or the like), pathloss reference information which may contain index for SSB, CSI-RS or PRS; periodicity of SRSp transmission; spatial information such as spatial direction information of SRSp transmission (e.g., beam information, angles of transmission), spatial direction information of DL-RS reception (e.g., beam ID used to receive DL-RS, angle of arrival); or the like. “ID” may be used interchangeably with “index.”

In certain representative embodiments, measurement definitions are provided. For example, measurement definitions include at least one of RSRPP measurements, AoA measurements, relative delay measurements, or the like.

In one example, the measurements described herein can be defined as follows.

In one example, RSRPP (e.g., in terms of dBm, dBW, or the like) may be defined as the path-wise power measurement that may be associated with a path, where a path may be characterized by, in one example, an i-th measurement component (e.g., i-th delay component, i-th AoA component, or the like) of the resource elements that carry DL-RS signal(s). For example, the RSRPP associated with the 1-st path measurements (e.g., 1-st delay component, 1-st AoA component, or the like) corresponds to the power contribution associated with the first detected path in time, and so on.

As used herein, an RSRPP (or RSRP) threshold may be defined with respect to a reference path RSRPP (or RSRP) (e.g., threshold of 3 dB lower than that of first path). In this case, the threshold may be −3 dB.

In one example, the AoA (e.g., measured in degrees, radians, or the like) may be defined as the azimuth and/or the vertical angle with which the WTRU receives the transmitted RS with respect to a reference direction. This reference direction may either be defined in the global coordinate system (e.g., geographical north) or in the local coordinate system (e.g., orientation of the WTRU measured in terms of Euler angles (e.g., degrees, radians, or the like)). In one example, the WTRU may measure the AoA per path associated with the received DL-RS. The WTRU may determine the AoA based on a process (e.g., subspace-based processes such as MUSIC/ESPIRIT) and/or based on the angles of the one or more Rx beams used to receive the RS (e.g., angle associated with the Rx filter) if the WTRU is able to perform Rx beamforming, based on WTRU capability. The resolution of the measured AoA may depend on the number of antenna elements and/or the antenna pattern at the WTRU, the granularity of Rx beams by the WTRU, or the like.

In one example, a relative delay (e.g., measured in terms of number of symbols, slots, frames, subframes, seconds, or the like) measurement of a path (e.g., i-th path) may be defined as the time duration associated with the delay component (e.g., i-th delay component) of the resource elements that carry received DL-RS with respect to the reference delay component (e.g., 1-st delay component of the DL-RS). The granularity of measuring the excess delays may be dependent on the time measurement resolution capability of the WTRU. This capability, in one example, may depend on the signal bandwidth for sensing. Additionally, the resolution may also depend on the ability of the WTRU to process (e.g., compute FFT) large frequency domain samples.

In certain representative embodiments, a sensing target and EO are provided. For example, herein, a sensing target may refer to any object (e.g., human, unmanned aerial vehicle (UAV), vehicles, or the like) in the environment for detection by at least one sensing entity (such as a sensing transmitter, sensing receiver, network, or the like). For example, in a smart home intruder detection scenario, the WTRU may sense (e.g., detecting, tracking, or the like) a human intruder, and hence the WTRU may identify the human intruder as a sensing target.

Herein, an EO may be defined as any object in the environment that at least one sensing entity (such as a sensing transmitter, sensing receiver, network, or the like) does not detect. For example, in a smart home intruder detection scenario, the WTRU may not detect a piece of furniture in the room, and hence the WTRU may identify the furniture as an EO. In some examples, the EO may be characterized by properties (e.g., size, material, velocity, or the like) similar to those of the sensing target, and such EO may be referred to as EO type 1. In other examples, the EO may be characterized by properties different than those of the sensing target, and hence such EO may be referred to as EO type 2. The type of EO may depend on the sensing target. For example, for a UAV sensing target, a bird may be identified as an EO type 1 and a building may be identified as EO type 2 due to the similarities or differences in their properties.

In one example, a sensing target in one scenario can be identified as an EO in another scenario. Hence, herein, the procedures defined for detection of a sensing target can be interchangeably applied to the procedures for detection of EO and vice-versa.

Herein, a sensing clutter may be defined as sensing noise present due to noise or interference in the environment.

In certain representative embodiments, false alarm and missed detection are provided.

In one example, an event of a false alarm may be defined as the event of not detecting the presence of sensing target/EO when the sensing target/EO is present.

In one example, an event of missed detection may be defined as an event of falsely detecting the presence of sensing target/EO when the sensing target/EO is not present.

In one embodiment, the probability of such event(s) (e.g., events of false alarm and missed detection) may be determined based on one or more measurements associated with at least one of the following: at least one measurement, at least one path, at least one DL-PRS resource, at least one DL-PRS resource set, at least one DL-PRS beam, at least one TRP, at least one time window, combinations of the same, or the like.

In one embodiment, the WTRU may be configured to determine and/or report the probability of false alarm based on the measurements associated with at least one of above-mentioned elements. For example, the probability of false alarm can be determined based on one measurement (e.g., RSRPP) associated, e.g., with a sensing target or an EO, where the WTRU may determine and/or report the likelihood that measurement does not correspond to a reflection from a sensing target or an EO. Likewise, the WTRU may determine and/or report the probability based on more than one measurement (e.g., a combination of RSRPP and RCS) of a path to indicate the likelihood that the combination of measurements does not arise from a sensing target or an EO. The probability of false alarm based on measurements from more than one path determined and/or reported by the WTRU may indicate the likelihood that the multiple path measurements detected as an EO or a sensing target does not correspond to the reflections arising from the sensing target or an EO. Similarly, the probability of false alarm based on the measurements based on at least one resource, at least one resource set, at least one TRP and/or at least one time window determined and/or reported by the WTRU may indicate the likelihood of the sensing target and/or EO falsely detected based on the measurements.

In another embodiment, the WTRU may be configured to determine and/or report the probability of missed detection based on the measurements associated with at least one of the above-mentioned elements. For example, the WTRU may be configured to determine and/or report the probability of missed detection associated with at least one measurement (e.g., RSRPP) to indicate the likelihood that a measurement (e.g., not detected as an EO or a sensing target) corresponds to a reflection from a sensing target or an EO. Likewise, the WTRU may be configured to determine and/or report the probability of missed detection associated with more than one measurement (e.g., a combination of RSRPP, relative delay, or the like) to indicate the likelihood that the measurements (e.g., not detected as a target or an EO) corresponds to a reflection from a sensing target or an EO. The probability of missed detection determined and/or reported by the WTRU associated with measurements of at least one resource, at least one resource set, at least one TRP, and/or at least one time window may indicate the likelihood of sensing target and/or an EO being present within the associated measurements but not detected.

In one embodiment, the WTRU may be configured to determine the probabilities of false alarm and/or missed detection as a confidence value for the likelihood of detecting a sensing target and/or an EO. For example, the WTRU may be configured to determine the probability of false alarm as a confidence metric for determining if the sensing targets or EOs can be accurately detected based on measurements (e.g., associated with one or more paths, DL-PRS resource/resource set, time window, or the like). Likewise, the WTRU may be configured to determine the probability of missed detection as a confidence metric for determining the likelihood of sensing targets or EOs not being detected although present.

For example, a representation of the probabilities and events of false alarm or missed detection is provided. In one example, the probabilities of false alarm or missed detection and the associated procedures described herein may be valid for any other such metric that indicates quality of measurement for any sensing procedure(s). The examples in this disclosure are presented based on probabilities and/or events of false alarm or missed detection; however, the procedures described herein may be valid based on any of such indicators of confidence, uncertainty, accuracy, precision, resolution or similar type of quality indicator of measurement (e.g., sensing measurement, path measurement, downlink measurement, or the like).

In one embodiment, the WTRU may be configured to determine and/or report the probabilities of false alarm and/or missed detection categorically or numerically. For example, the WTRU may determine and report the probabilities in terms including at least one of the following: discrete hard indicator categorical values such as “high,” “medium,” or “low,” or the like; discrete hard indicator numerical values such as 0 and 1 or 0 and 100, or the like; continuous soft indicator values, e.g., within 0 and 1 or 0 and 100; combinations of the same; or the like.

In the above examples, a low probability value may be mapped to a discretized lower probability indicating values such as “low,” “0” or “0.1,” and a high probability value may be mapped to discretized higher probability indicating values such as “high,” “1,” “0.9,” or the like.

In another example, the soft indicator value may be a probability value expressed between a minimum (e.g., 0) and a maximum (e.g., 1, 100, or the like). In another example, the soft indicator may indicate likelihood of presence of the target or likelihood of no presence of the target.

In one example, an event of false alarm or missed detection may be considered as a determination based on a hard indicator (e.g., binary indication 0 or 1); whereas, probability of false alarm or missed detection may be considered as a soft indicator (e.g., between 0 and 1). The WTRU may report the event or the probability to the network accordingly. Herein, we use the term false alarm or missed detection or the probabilities of false alarm or missed detection to define both the probability (e.g., soft indicator) or the event (e.g., hard indicator).

In one example, the WTRU may receive a request from the network (e.g., LMF, gNB, or the like) to determine and report an indicator (e.g., soft or hard indicator) related to the presence of the target. The WTRU may receive the request based on the reported WTRU capability (e.g., whether the WTRU is capable of generating the indicator). The WTRU may report the indicator after determination.

In one example, the WTRU reports the probability of false alarm or missed detection as the difference between the current value compared to a previously configured or reported value, so as to reflect a relative increase or decrease in the detection performance. The reporting format may be based on numerical values or simple up/down commands to indicate an increase or decrease in the false alarm or missed detection probability.

In certain representative embodiments, path measurements are provided. In one example, the WTRU may be configured to perform path measurements, which may correspond to measurements corresponding to multipath reflections. Herein, a path may be referred to as at least one or a group of measured multipath component(s). A path may be characterized by at least one measurement as follows: one or more RSRPP measurement(s), one or more AoA (e.g., per path) measurement(s), one or more relative delay measurement(s), one or more delay spread measurement(s), one or more RCS, one or more micro-doppler measurement(s), one or more carrier-phase (e.g., per path) measurement(s), one or more doppler shift (e.g., per path) measurement(s), one or more doppler spread measurement(s), combinations of the same, or the like.

In one example, the WTRU may determine that a measured multipath as a path based on at least one of the following conditions: at least one of the measurements (e.g., RSRPP, doppler shift, or the like) corresponding to the multipath component is above or below a (pre)configured threshold; at the least of the statistics (e.g., variance) of at least one of the measurements (e.g., RSRPP, doppler shift, or the like) corresponding to the multipath component is above or below a (pre)configured threshold; change in at least one of the measurements (e.g., between (e.g., consecutive) two measurement occasions) is above or below a (pre)configured threshold; combinations of the same; or the like.

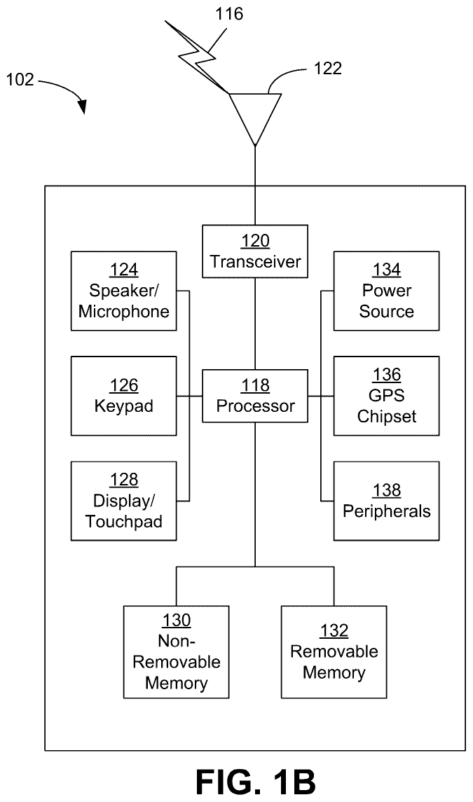

FIG. 2A depicts an environment 200 including a WTRU 205, object #1 210, object #2 215, and TRP 220. The TRP 220 transmits DL-PRS ID #1 225. Path #1 230a extends between the WTRU 205 and the TRP 220 and is reflected by the object #2 215. Path #2 235a extends between the WTRU 205 and the TRP 220, and is reflected by the object #1 210. Path #3 240a also extends between the WTRU 205 and the TRP 220 and is reflected by the object #1 210. Line of sight (LoS) Path 245a extends between the WTRU 205 and the TRP 220. FIG. 2B depicts a chart 280 with RSRPP (on the y-axis) for each of Path #1 230b (corresponding with the Path #1 230a), Path #235b (corresponding with the Path #2 235a), Path #3 240b (corresponding with the Path #3 240a), and LoS Path 245b (corresponding with the LoS Path 245a) versus relative delay (on the x-axis) with respect to the LoS Path 245b. FIG. 2C depicts a chart 290 with RSRPP (on the y-axis) for each of Path #1 230c (corresponding with the Path #1 230a; not labeled in FIG. 2C), Path #235c (corresponding with the Path #2 235a), Path #3 240c (corresponding with the Path #3 240a), and LoS Path 245c (corresponding with the LoS Path 245a; not labeled in FIG. 2C) versus AoA (on the x-axis).

In one embodiment, a WTRU 205 may be configured to associate two path measurements (e.g., with a same object) if the difference between at least one measurement of a first path (e.g., AoA of path #2 235a in FIG. 2A and path #2 235c in FIG. 2C) and the corresponding measurement of a second path (e.g., AoA of path #3 240a in FIG. 2A and path #3 240c in FIG. 2C) is above or below a (pre)configured threshold.

In one example, the WTRU 205 may be configured by the network (e.g., TRP 220) to determine a path ID to at least one or more of the measured or determined paths. The WTRU 205 may receive a set of path ID(s) from the network and allocate them to the paths. In another example, the WTRU 205 may be configured to allocate path IDs for a path based on at least one of the following: the order with which the WTRU 205 receives the path, e.g., the first arrival path (e.g., LoS path 245a) may be allocated path #1, the second arrival path may be allocated ID #2; at least one of the measurements (e.g., relative delay, FIG. 2B) associated with the path; combinations of the same; or the like.

An example of path measurement is illustrated in FIGS. 2A-2C, where the WTRU 205 is configured to determine a path based on a measurement (e.g., RSRPP, FIGS. 2B-2C) above a (pre)configured threshold. Similarly, the WTRU 205 is configured to determine path association based on AoA differences between two measurements (e.g., FIG. 2C). The WTRU 205 is configured to allocate path ID(s) to the detected paths (e.g., LoS path 245a, path #1 230a, path #2 235a, path #3 240a, or the like) as illustrated in FIG. 2A.

In another embodiment, the WTRU may be configured to allocate an object ID to a set of associated paths. For example, as shown in FIGS. 2A-2C, Object #1 210 may be allocated to a set of associated paths, e.g., path #2 235a and path #3 240a. Also, for example, the allocation of Object #1 210 to the association of path #2 235a and path #3 240a may be based on a similar RSRPP compared to relative delay (FIG. 2B) and/or on a similar RSRPP compared to AoA (FIG. 2C). In one embodiment, the WTRU may receive a set of object ID(s) and the WTRU may allocate to the path measurements.

In one example, the WTRU may be configured to report at least one of the following to the network: at least one path ID; at least one object ID associated with one or more paths; at least one measurement (e.g., path measurement such as RSRPP, AoA, doppler spread, or the like); at least one statistic (e.g., variance) associated with at least one measurement; at least one DL-PRS resource ID(s), DL-PRS resource set ID(s) and/or DL-PRS beam ID(s) (e.g., associated with the path measurement); measurement timestamp (e.g., in terms of time index units) associated with at least one measurement; combinations of the same; or the like

An example of a measurement may be a channel impulse response (CIR). A CIR, comprising of N paths, may be defined by the following equation (1), as follows:

$$h ( t ) = {\sum }_{k = 1}^{N} {h}_{k} ( t ) δ ( t - {τ}_{k} ) \qquad ( 1 )$$

where hₖ(t) and τₖ are time-varying complex valued coefficients (e.g., expressed by a+bj where j=\sqrt{−1}) for the CIR and delay, measured in seconds, for the kth path, respectively. The delta function is defined as S(t)=1 for t=0 and S(t)=0 for t≠0.

In some examples, it may be assumed that the coefficients are constant over time, for example, such that hₖ(t)=hₖ. The WTRU may report the amplitude of CIR hₖ and τₖ for each path k to the network. The WTRU may report the number of paths, N, to the network. Alternatively, the WTRU may receive hₖ and τₖ for each path k from the network and/or the number of paths.

In another example, the WTRU may obtain at least one CIR from the network. The CIR may be associated with at least one of the following: at least one DL-RS configuration(s) such as DL-RS resource IDs; at least one PFL ID; at least one TRP ID; at least one cell ID; combinations of the same; or the like.

In one example, the WTRU may determine that the CIR represents the channel between the above-mentioned associated entity and the WTRU.

For example, CIR may be represented by a delay profile (DP) or power delay profile (PDP). A PDP may be defined as a set of delays and power profiles, such as [τ₀, τ₁, . . . , τ_{N-1}] and [p₀, p₁, . . . , p_{N-1}], where Pk may correspond to relative power at the kth path compared to the first path. A DP may be defined as a set of delays [τ₀, τ₁, . . . , τ_{N-1}] which indicate path delays for each path above p_{threshold}. A WTRU may receive p_{threshold} from the network to derive a delay profile from a power delay profile.

In one example, a WTRU may receive an indication from the network on how to generate CIR, PDP, or DP based on timing, phase and/or power measurements. In one example, the WTRU may send a request to the network to receive an indication on which methodologies to use to generate CIR, PDP, or DP based on the measurements the WTRU made. For example, the WTRU may receive a message from the network (e.g., via LPP, RRC, MAC-CE, DCI, or the like) indicating the DL-RS resource indices and associated measurement type(s) (e.g., RSTD, AoA, or the like) to be used to generate CIR, PDP, or DP. In one example, the WTRU may receive an indication from the network indicating to generate at least one of CIR, PDP, or DP.

In one example, a WTRU may receive a threshold (e.g., power threshold) from the network and timing range (e.g., Ops to lys), timing granularity (e.g., every 0.1 μs in the indicated timing range, 100 sample points in the indicated timing range) of CIR, PDP and/or DP. In this case, a WTRU may determine to report power and timing (e.g., relative timing compared to a reference timing or absolute timing) for any samples whose received power exceeds a threshold.

In another example, a CIR reported by a WTRU to the network may be defined by a configured number of samples (e.g., N) where the WTRU is configured with a granularity of samples (e.g., X seconds apart). The number of samples may be defined within a window. The WTRU may report samples whose RSRP is over the configured threshold or report a given number of the highest RSRP among the samples. The WTRU may indicate locations or a sample index of samples where the WTRU measures a given number of samples having a highest RSRP or the highest among the samples. The first sample may be defined as the earliest arriving path, e.g., first path. In another example, the samples may be defined with respect to the reference timing (e.g., time of arrival (ToA) of reference or indicated DL-RS, ToA of the earliest arriving DL-RS, or the like). The WTRU may report timing, phase, and/or power information per sample. The determined reference timing or first path may be rounded up or down to the defined timing granularity. The CIR, PDP, or DP may be defined as the impulse response between a WTRU and TRP or associated with a DL-RS (e.g., DL-RS resource ID) or DL-RS resources (e.g., DL-RS resource IDs).

In one example, the WTRU may report the time of arrival of DL-RS corresponding to the reflected signal. When the WTRU indicates, e.g., in the report sent to the network, the ToA of DL-RS corresponding to the reflected signal against the target, the WTRU may indicate the relative timing with respect to the reference timing (e.g., first sample or ToA of the reference RS, ToA corresponding to the LOS, or the like). The WTRU may report, to the network, a reference timing (e.g., based on the RS configured by the network, first sample within the window, or the like).

In another example, the WTRU may report AoA for samples. The WTRU may report AoA for samples whose RSRP is over a configured threshold. The WTRU may report AoA for a given number of samples with a given number of highest RSRPs within the window.

In another example, the WTRU may receive the relative delay information from the network, with respect to the reference timing. The relative delay information is associated with a DL-RS indicated by the network. The relative timing information may correspond to the relative ToA of reflected DL-RS against the target where relative ToA is defined with respect to the reference timing. The relative delay information sent from the network may be used by the WTRU to estimate the location of the target. The relative delay information may be used by the WTRU to determine ToA of the associated DL-RS. The relative delay information may be associated with an expected AoA (e.g., reception angle from which the WTRU receives the DL-RS) or AoD (e.g., angle of departure at which the DL-RS was transmitted).

Herein, the CIR may be used alternatively to the path measurements where the CIR delay samples (e.g., in x-axis) may be interchangeably used with relative delay or path delay measurements. The amplitude measurement of the CIR (e.g., in y-axis) may be interchangeably used as any power measurement metric such as RSRPP or RSRP.

The WTRU may send measurements in a report to the network (e.g., LMF, gNB, or the like) via a semi-static (e.g., LPP, RRC, or the like) or dynamic message (e.g., UCI, UL MAC-CE, or the like).

In the examples herein, DL-RS (e.g., CSI-RS, DM-RS, TRS, or the like) and SSB may be used interchangeably.

In certain representative embodiments, one or more target detection procedures configurations are provided. For example, the target detection procedures include at least one of one or more configurations for target detection, assistance information for target detection, procedures for target detection, false alarm and missed detection, reporting, subsequent WTRU behavior, combinations of the same, or the like.

For example, one or more configurations for target detection are provided. Also, in one example, the WTRU may receive at least one DL-PRS configuration for target detection from the network (e.g., LMF, gNB, entity that configures reference signals to the WTRU) in the downlink physical channels, such as PDSCH or PDCCH, via higher layer signaling such as MAC-CE, RRC, DCI, or via LPP messages.

For example, one or more trigger conditions for target detection are provided. In one embodiment, the WTRU may be configured to request the network for DL-PRS configuration for target detection. The WTRU may send the request based on at least one or more trigger conditions. For example, the trigger conditions include at least one of a WTRU receiving one or more indications, a WTRU determining one or more measurements, a WTRU located within an indicated area, a change of WTRU location, a change in WTRU rotation, a velocity of the WTRU, an error in (e.g., estimated) location and/or velocity of the WTRU, a WTRU receiving a retransmission request, a WTRU failing to decode information from the wireless network, combinations of the same, or the like.

For example, a trigger for target detection includes the WTRU receiving at least one indication (e.g., explicitly or implicitly) from the network for target detection. In one example, the indication may be at least one of the following: an explicit indication (e.g., DCI, MAC-CE, or the like) to activate one or more configuration(s) associated with the target detection; a configuration (e.g., DL-PRS, measurement, reporting, SRSp, or the like) and/or assistance information associated with target detection; an activation indication of the time window or any configuration associated with target detection; combinations of the same; or the like.

Also, for example, a trigger for target detection includes the WTRU determining that at least one measurement (e.g., RSRP) associated with at least one DL-RS (e.g., SSB, CSI-RS, or the like)) satisfies (e.g., (pre)configured) conditions for requesting configuration for target detection. For example, the WTRU determining that at least one measurement associated with the at least one DL-RS satisfies conditions for requesting configuration for target detection includes at least one of the following: at least one measurement(s) (e.g., per path) which are above or below a (pre)configured threshold; a difference between at least one measurement(s) between two measurement occasion(s) which are above a (pre)configured threshold; at least one statistic (e.g., variance) associated with at least one of the measurements which are above or below a (pre)configured threshold; combinations of the same; or the like.

Further, for example, a trigger for target detection includes the WTRU being located within an indicated area (e.g., coarse location, zone ID, or the like).

In addition, for example, a trigger for target detection includes the change of a WTRU's location (e.g., between measurement occasions) being above or below a (pre)configured threshold.

Moreover, for example, a trigger for target detection includes the change in WTRU's rotation (e.g., between measurement occasions) being above or below a (pre)configured threshold.

Furthermore, for example, a trigger for target detection includes the velocity of the WTRU being above or below a (pre)configured threshold.

Additionally, for example, a trigger for target detection includes the error in location and/or velocity estimate of the WTRU being above or below a (pre)configured threshold.

Still further, for example, a trigger for target detection includes the WTRU receiving at least one retransmission request from the network, for instance, for uplink channel (e.g., PUCCH, PUSCH, or the like) or UL RS (e.g., SRSp).

Even further, for example, a trigger for target detection includes the WTRU failing to decode at least one of the downlink channels (e.g., PDSCH, PDCCH, or the like) or DL-RS (e.g., DL-PRS) transmitted by the gNB or a transmitter.

For example, WTRU capability information for target detection is provided. In another example, the WTRU may be configured by the network to report capability information for target detection to the network. Also, for example, the WTRU configured by the network to report capability information for the target detection to the network includes at least one of the following: an indication of a capability to perform, process and/or report (e.g., to the network) measurements (e.g., per path sensing measurements); the (e.g., maximum, minimum) sensing delay range measurement capability (e.g., distance where the WTRU may be capable of performing target detection); the (e.g., maximum, minimum) sensing angular range measurement capability (e.g., angle(s) or range of angle(s) where the WTRU may be able to target detection); an indication of a capability of the WTRU to perform measurements, processes and/or determine its own location, velocity, and/or orientation; the (e.g., maximum, minimum) number of paths and/or sensing targets the WTRU may be able to perform measurements on and/or process and/or report (e.g., simultaneously) to the network; the (e.g., maximum, minimum) granularity of measurement, and/or reporting (e.g., in terms of time duration units) the WTRU may be able to perform; or an indication of whether the WTRU can determine the events and/or probabilities of false alarms and/or missed detection; combinations of the same; or the like.

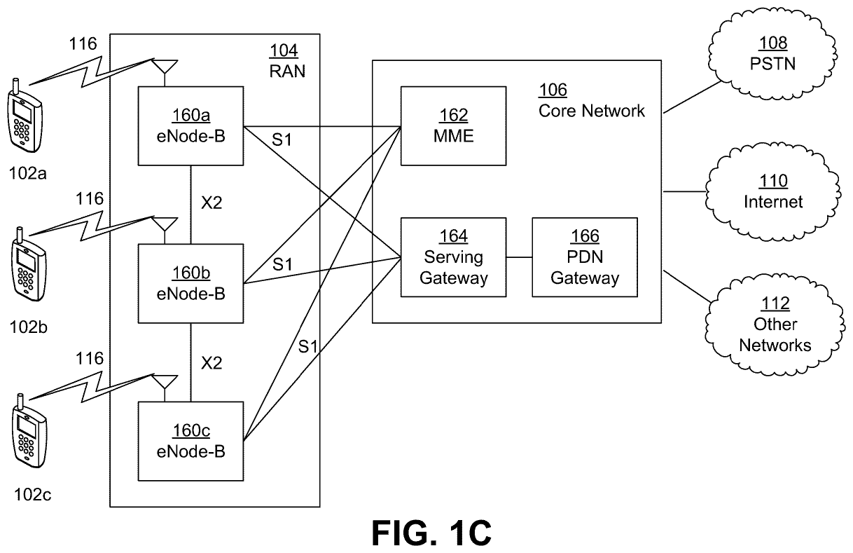

In one embodiment, the WTRU may receive the configuration for target detection from the network after reporting its capability information. The capability information may act as the request (e.g., implicit) to the network to provide or activate the configuration associated with target detection, as illustrated in the signaling diagram in FIG. 3.

In another example, if at least one or a combination of the above-mentioned trigger conditions are not satisfied, the WTRU may determine to terminate the detection procedure.

FIG. 3 shows a diagram illustrating an initiation of a detection procedure, according to one or more embodiments. In diagram 300, at 330, a network (e.g., gNB) 310 (which may be the same as any of previously mentioned gNBs 180a-180c, or the like) requests capabilities to a WTRU 320 (which may be the same as any of previously mentioned WTRUs 102a-102d or 205, or the like). At 340, the WTRU 320 provides a capabilities message or information indicative of its capabilities back to the gNB 310. At 350, the gNB 310 transmits a message to the WTRU 320 indicating to initiate a target detection procedure.

In certain representative embodiments, assistance information for target detection is provided. For example, in one embodiment, the WTRU may receive assistance information for target detection from the network. Also, for example, the assistance information may include at least one of a detection time window, a DL-PRS resource indication for detection, a path indication for detection, a detection area indication, a sensing target path profile, an EO path profile, association of a configuration with a target or EO path profile, combinations of the same, or the like.

Regarding a detection time window, in one example, the WTRU may be (pre)configured with at least one time window for the detection of a sensing target. The window(s) for the second procedure may be characterized by at least one of the following parameters: time window ID(s); start and/or end times (e.g., expressed in terms of time index units); a duration (e.g., expressed in terms of time duration units); an offset (e.g., in terms of time duration units) where the reference time may be the same as the ones mentioned for start and/or end time; periodicity (e.g., expressed in terms of time duration units); combinations of the same; or the like. Regarding the start and/or end times, for a relative time, the reference time instance may be at least one of the following: an initial value of a system frame number (SFNO) time; the time instance when WTRU received the at least one indication (e.g., configuration(s), indication to initiate detection, or the like) from the network; at least one measurement and/or reporting time instance by the WTRU; combinations of the same; or the like.

In one example, the WTRU may receive the activation of time window (e.g., with time window ID and one or more of the time window parameters).

Regarding a DL-PRS resource indication for detection, in one example, the WTRU may be configured to perform target detection along a (pre)configured DL-PRS resource. The WTRU may receive an indication of at least one DL-PRS ID indicating to the WTRU to perform measurements for target detection based on measurements on the DL-PRS ID. In another embodiment, the WTRU may receive a sequence of DL-PRS ID(s). The sequence may indicate the DL-PRS resource transmission pattern such as beam sweeping pattern.

In another embodiment, the DL-PRS ID may be associated with at least one area (e.g., detection area). The WTRU may perform sensing measurements based on the DL-PRS ID being associated with at least one area. The WTRU may determine to perform detection based on the spatial relationship associated with the indicated DL-PRS ID. For example, the DL-PRS ID may be associated with at least one DL-RS or UL-SRSp, for instance, via spatial relationship information or QCL (e.g., type D) relationship associated with the DL-PRS ID.

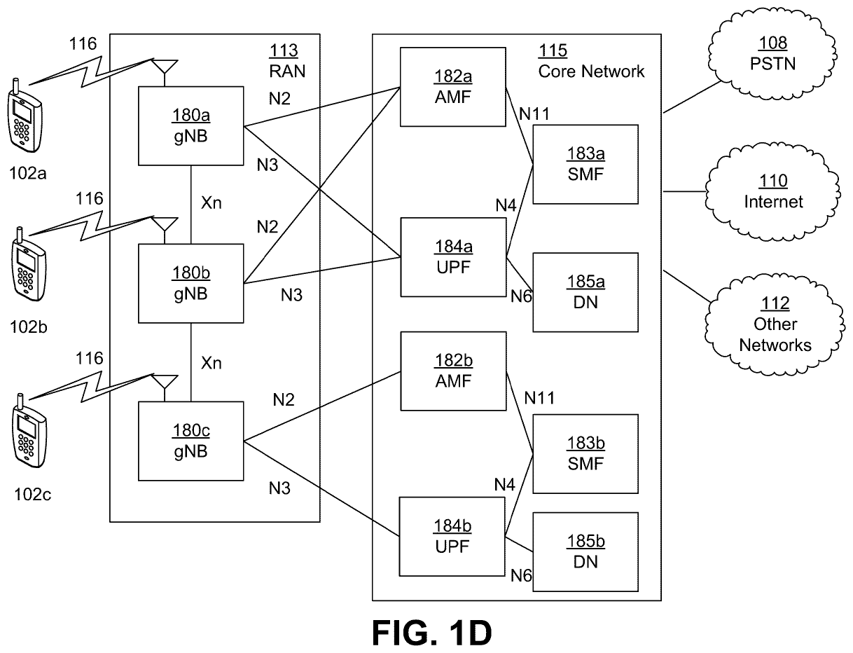

FIG. 4 shows a diagram illustrating how a WTRU may associate at least one RS with at least one area, according to one or more embodiments. In diagram 400, WTRU 410 (which may be the same as any of the previously mentioned WTRUs 102a-102d, 205, or 320, or the like) may associate area #1 420 (e.g., Zone ID #1) with DL-PRS ID #1 450. Similarly, the WTRU 410 may associate area #2 430 (e.g., Zone ID #2) with DL-PRS ID #2 460. DL-PRS ID #1 450 and DL-PRS ID #2 460 may be transmitted by TRP 440 (which may be the same the previously mentioned TRP 220, or the like).

As illustrated in FIG. 4, the WTRU 410 may be configured with an association between at least one RS (e.g., DL-RS, UL-RS, or the like) and an area (e.g., detection area). The WTRU 410 may be configured to measure the associated DL-PRS based on the target sensing service area for detection purposes. Likewise, the WTRU 410 may be indicated with DL-PRS configurations associated with the area. The WTRU 410 may be configured to activate or deactivate the associated configuration based on the area detected by the WTRU 410.

In one example, the WTRU may be configured with priority levels associated with DL-RSs and/or areas for measurement. If the WTRU is configured with more than one DL-RSs or areas for measurements, the WTRU may determine an order of measurements based on the associated priority level (e.g., the WTRU may make a measurement on the DL-RS with the highest level of priority, and the WTRU may make measurements on the area with the highest level of priority).

Regarding a path indication for detection, in one example, the WTRU may receive an indication of at least one path indication (e.g., path ID) or a range of path indications as assistance information for performing detection. The WTRU may receive at least one of the following as a path indication: at least one or a range of path ID(s); at least one or a range of measurements associated with path ID(s); at least one or a range of relative delay measurement indication (e.g., relative to the first arrival path or LoS path); at least one or a range of AoA measurement indications (e.g., relative to a reference direction such as true North); at least one or a range of doppler spread (e.g., per path) measurement indications; at least one or a range of carrier phase (e.g., per path) measurement indications; combinations of the same; or the like.

In these examples, the range may either be indicated with a maximum and/or minimum measurement value and/or an expected measurement value and/or a tolerance level. The WTRU may be configured to associate a measurement with the indicated path ID if the measurement is within the indicated minimum or maximum range or with the tolerance level of the indicated expected measurement value.

Regarding a detection area indication, in one example, the WTRU may receive an indication of a detection area. Also, for example, the WTRU may perform the measurement detection on the indicated detection area. The area indication may be in terms of at least one of the following: a sensing target ID, a sensing target type, a property, a target sensing service area indication, a reference sensing target measurement value and/or reference measurement range, a reference associated with a reference measurement, prior information, an indication of a reference measurement indication, a statistic, a detection time window, a sensing condition, combinations of the same, or the like.

Further, for example, the WTRU may receive at least one of the following: at least one sensing target ID; at least one sensing target type (e.g., such as UAV, vehicle, human, or the like); at least one property associated with the sensing target ID, including target physical or mobility characteristic such as target size, target velocity, target acceleration (e.g., in terms of meters per second squared), target material (e.g., concrete, metal, plastic, or the like), target material properties (e.g., material conductivity, permittivity) or the like; target size may be indicated in terms of categorial size (e.g., large, small, medium, 1, 2, or the like) or numerical size (e.g., [height, width, depth], e.g., in terms of meters, relative size compared to a reference object, or the like); target velocity may be indicated in terms of meters per second or categorical value such as [mobile, static] or if the target is moving [fast, slow] or the numeric equivalent (e.g., [0, 1, . . . , N−1] for N-ary discrete values) or the like; at least one target sensing service area indication, e.g., in terms of coarse location, zone ID, or the like associated with the sensing target ID; at least one reference sensing target measurement value and/or reference measurement range (e.g., minimum, maximum) associated with the sensing target (e.g., reference path ID, reference relative delay, reference amplitude (e.g., associated with the power delay profile of the target path), reference RSRPP, reference doppler spread, reference carrier phase, reference radar cross section (RCS) in terms of, e.g., dBsm, reference frequency and/or the associated amplitude in the micro-doppler profile, or the like); at least one reference associated with the reference measurements; at least one reference TRP ID (e.g., associated with the measurement); at least one reference DL-PRS or reference UL-RS indication (e.g., in terms of DL-PRS ID, UL-RS ID, or the like) associated with the measurement; at least one reference path ID (e.g., associated with the measurement such as LoS path, n-th path); at least one reference direction (e.g., associated with angular measurements); at least one prior information; prior probability of the sensing target (e.g., associated with at least one of the following: at least one reference sensing target measurement value, target sensing service area, DL-PRS resource ID, TRP ID, Cell ID, or the like); at least one indication of reference measurement indication (e.g., measurement occasion indicator and/or reporting occasions such as measurement configuration ID, reporting configuration ID, report ID or the like) associated with the sensing target; at least one statistic (e.g., distribution, variance, moment) associated with at least one or a combination of the reference target measurement value or the measurement range; at least one detection time window (e.g., time window ID); at least one sensing condition associated with the sensing target; combinations of the same; or the like. For example, at least one sensing condition associated with the sensing target includes at least one of the following: the WTRU is located in a (pre)configured geographical area (e.g., sensing target service area); the change in WTRU location between measurement occasions is above or below a (pre)configured threshold; the WTRU velocity is above or below a (pre)configured threshold; the change is WTRU velocity (e.g., between measurement occasions) is above or below a (pre)configured threshold; the change in WTRU rotation between measurement occasions is above or below a (pre)configured threshold; at least one measurement (e.g., RSRP) associated with at least one DL-RS (e.g., SSB) is above a (pre)configured threshold; combinations of the same; or the like.

Regarding an EO path profile, in another example, the WTRU may be configured with the EO path profile by the network. The EO path profile may comprise information regarding one or more EO(s) that the WTRU may detect including types, characteristics, mobility, distribution, or the like. The WTRU may receive at least one of the following types of assistance information in the EO path profile from the network: at least one EO ID (e.g., EO type such as UAV, vehicle, human, walls, buildings, or the like); at least one EO type (e.g., EO type 1, EO type 2, or the like); at least one of the assistance information described in the target profile by replacing the term “target” or “sensing target” with “EO”; combinations of the same; or the like.

In another example, the WTRU may receive, e.g., from the network, profiles related to one or more EOs in terms of details of measurements. For example, the WTRU may receive a time range with respect to a reference time (e.g., first path, first detected path, first time of arrival, or the like), indicating that the WTRU may make measurements related to the EO (e.g., samples above RSRP threshold). The WTRU may receive EO profiles (e.g., radar cross section values) from the network.

Regarding an association of a configuration with a target EO path profile and/or an EO path profile, in one embodiment, the WTRU may be indicated with an association. For example, the associate may be between at least one of the following: at least one DL-PRS configuration (e.g., configuration ID, measurement configuration ID, reporting configuration ID, or the like); at least one target path profile (e.g., target ID); at least one EO path profile (e.g., EO ID); at least one sensing target or EO service area; at least one detection time window (e.g., time window ID); combinations of the same; or the like.

For example, the WTRU may receive at least one configuration associated with a sensing target or an EO. The configuration may be an implicit indication from the network to detect the sensing target or the EO.

The association may be an indication to the WTRU by the network to activate and/or deactivate at least one of the configurations. An activation or deactivation indication of one configuration may be an implicit indication to the WTRU to activate or deactivate at least one of the associated configurations. For example, the WTRU may implicitly indicate a sensing target to detect by activating a configuration associated with the target path profile.

In certain representative embodiments, one or more procedures for target detection are provided. For example, the one or more procedures for target detection include at least one of an association of a sensing target with a (e.g., DL-PRS) configuration for detection, a determination of a resource (e.g., DL-PRS ID) for detection measurement, one or more indications from the network, at least one assistance information indicator from the network, a determination of a resource based on at least one measurement, one or more conditions for detection of a sensing target, one or more conditions for detection of a sensing target, multiple measurements associated with a detected sensing target or EO, combinations of the same, or the like.

Regarding an association of a sensing target with a DL-PRS configuration for detection, in one embodiment, the WTRU may be receiving the DL-PRS resource(s) for sensing target detection. In one example, the WTRU may receive an indication at least one sensing target (e.g., sensing target ID, reference path ID associated with sensing target, or the like) to detect. The indication may either be an explicit indication or an implicit indication.

In case of explicit signaling (e.g., sensing target ID), such may be an indication to activate a DL-PRS configuration. Likewise such indication may also be a deactivation indication of the DL-PRS associated with any sensing target other than the indicated sensing target.

An example of implicit indication may be the configuration or an activation indication of a configuration for DL-PRS resource(s) associated with at least one sensing target (e.g., sensing target ID). Another example of the implicit indication may be a DL-PRS configuration indicating or associated with at least one of the assistance information indicators associated with the sensing target path profile.

For example, the WTRU may determine to detect a mobile sensing target if the configured DL-PRS corresponds to a configuration optimal for sensing a mobile target (e.g., DL-PRS bandwidth is above a (pre)configured threshold).

In another example, the WTRU may determine to detect a target with an associated target sensing service area if the DL-PRS beams are spatially aligned towards the indicated area or associated with the sensing target service area.

In another example, the WTRU may be configured to activate or request the activation of a configuration (e.g., among the set of configurations, in case of on-demand DL-PRS configuration). For example, the WTRU may be configured to activate or request the activation of the configuration based on at least one of the following conditions: the WTRU determines to activate or request to activate a configuration, the WTRU receives an indication from the network, the WTRU determines a configuration, combinations of the same, or the like.

For example, the WTRU determines to activate or request to activate a DL-PRS configuration associated with a sensing target it is capable of detecting. Also, for example, the WTRU determines to activate or request to activate the DL-PRS configuration associated with the sensing target it is capable of detecting based on at least one of the following: at least one WTRU capability information; for example, the WTRU may determine to detect a mobile sensing target (e.g., moving car) based on its capability to measure doppler shift measurements; for example, the WTRU may determine to detect a small sensing target (e.g., a small UAV) based on its maximum capable sensing delay resolution (e.g., corresponding to maximum bandwidth the WTRU is capable of processing), or the like; at least one WTRU state (e.g., WTRU location, WTRU velocity, or the like); for example, the WTRU may determine to detect a sensing target associated with a target sensing service area if the WTRU is also located in the same area; for example, the WTRU may determine to detect a static sensing target if the WTRU velocity is above a (pre)configured threshold, or the like; the WTRU determines to activate or request to activate a DL-PRS configuration associated with a sensing target if it satisfies at least one sensing condition associated with the sensing target; the WTRU receives an indication from the network to activate at least one DL-PRS configuration and/or the associated configurations; the WTRU receives the indication from the network to activate the at least one DL-PRS configuration and/or the associated configurations including at least one if: at least one detection time window (e.g., time window ID), at least one sensing target (e.g., sensing target ID), at least one EO (e.g., EO ID), combinations of the same, or the like; the WTRU determines a DL-PRS configuration based on at least one measurement associated with at least one DL-RS (e.g., SSB, CSI-RS, or the like); the WTRU determines the DL-PRS configuration based on the at least one measurement associated with the at least one DL-RS, including at least one of: the at least one measurement is above or below a (pre)configured threshold, the difference between at least one measurements (e.g., in two measurement occasions) is above or below a (pre)configured threshold, at least one statistic (e.g., variance) associated with a measurement is above or below a (pre)configured threshold, at least one WTRU state (e.g., distance from a TRP associated with the DL-PRS configuration, WTRU velocity, WTRU location, WTRU rotation, or the like) or the change in WTRU state (e.g., between two measurement occasions) is above or below a (pre)configured threshold, the accuracy estimates of at least one WTRU state (e.g., WTRU location, WTRU velocity, or the like) is above or below a (pre)configured threshold, or the like; combinations of the same; or the like.

In one embodiment, satisfaction of at least one of the above-mentioned conditions associated with at least one DL-PRS configuration or the associated configuration(s) may be an indication for the WTRU to request activation of the corresponding DL-PRS configuration or the associated configurations.

Similarly, the failure of satisfaction of at least one of the above-mentioned conditions may be an indication for the WTRU to request deactivation of the corresponding DL-PRS configuration or the associated configurations.

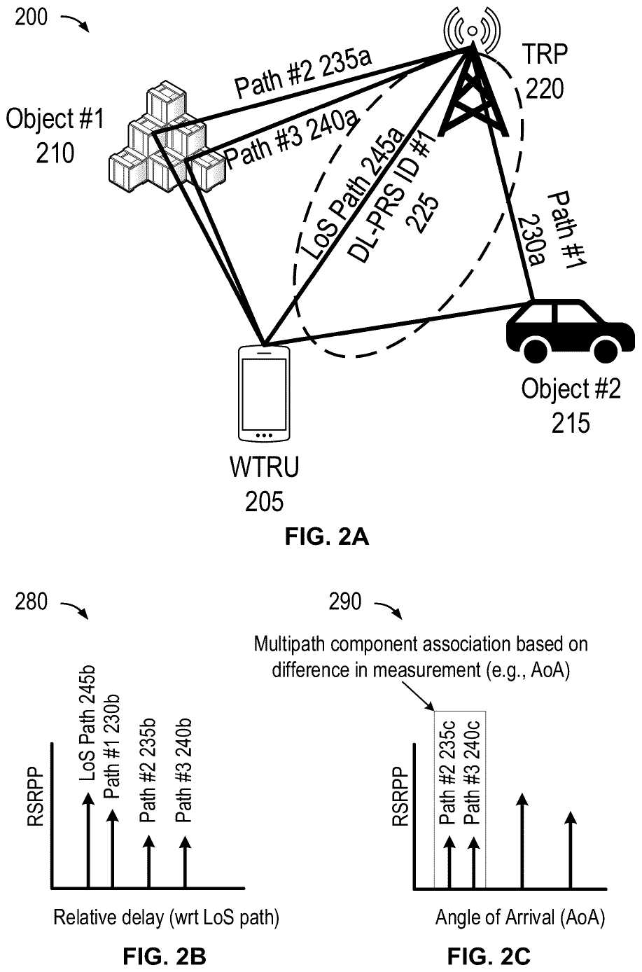

In one embodiment, the WTRU may receive an indication from the network to activate and/or deactivate at least one configuration for target detection. An example of the indication may be an acknowledgement (ACK) or a negative acknowledgement (NACK). This request and response are illustrated, for example, in FIG. 5.

FIG. 5 shows a diagram illustrating a DL-PRS configuration request from a WTRU, according to one or more embodiments. In diagram 500, at 530, a network (e.g., gNB) 510 (which may be the same as any of previously mentioned gNBs 180a-180c, or the like) transmits more than one DL-PRS configuration (e.g., DL-PRS config #1, DL-PRS config #2, or the like) to a WTRU 520 (which may be the same as any of previously mentioned WTRUs 102a-102d or 205, or the like). At 540, the WTRU 520 requests a DL-PRS config #1 from the gNB 510. At 550, the gNB 510 transmits an ACK message to the WTRU 520.

Regarding a determination of DL-PRS ID for detection measurement, in one embodiment, the WTRU may be configured and/or indicated with the DL-PRS resource(s) (e.g., DL-PRS resource ID(s)) where it may perform the measurements for detection of a sensing target.

In another example, the WTRU may be configured to determine the DL-PRS resource(s) (e.g., DL-PRS resource ID(s)) where it may perform the sensing measurements for target detection. For example, the WTRU may determine the DL-PRS resource(s) based on at least one of the following: an indication from a network, at least one assistance information indicator from a network, a resource determination based on at least one measurement, combinations of the same, or the like.

Regarding an indication from the network, in one embodiment, the WTRU may receive an indication from the network of DL-PRS resource ID(s) which the WTRU may determine to measure for target detection.

In another embodiment, the WTRU may receive an indication of a sensing target (e.g., target ID) and/or EO (e.g., EO ID) that the WTRU may be requested to detect. The WTRU may determine to perform measurements on the DL-PRS resource ID(s) associated with the corresponding Target ID and/or EO ID.

In another embodiment, the WTRU may receive an indication of the detection time window (e.g., window ID) and determine to perform measurements on the associated DL-PRS ID(s).

In another embodiment, the WTRU may receive an indication of a sequence of DL-PRS ID(s) (e.g., corresponding to a beam sweeping measurement). The sequence may be associated with the beam pattern where the WTRU may be expected to measure. The WTRU may perform detection measurement based on measurements on at least one of the indicated DL-PRS beam sequence.

Regarding at least one assistance information from the network, in one embodiment, the WTRU may be configured with a target sensing service area indication, and the WTRU may determine to perform sensing measurement on the DL-PRS ID(s) associated with the detection area. In another embodiment, the WTRU may be configured to determine the DL-PRS resources for measurement based on the indicated target sensing service area. For example, the WTRU may be configured to determine the DL-PRS resources for measurement based on at least one of the following: at least one DL-PRS ID(s) with beam direction (e.g., beam angle) that are spatially aligned with the indicated target sensing service area (e.g., illustrated in FIG. 4); at least one DL-PRS ID(s) with at least one measurement (e.g., AoA of at least one path) aligned with the indicated detection area; combinations of the same; or the like.

In another embodiment, the WTRU may be configured to determine the DL-PRS resource ID(s) based on the indicated reference measurement values (e.g., associated with the sensing target, and/or EO, and/or detection path index, or the like). The WTRU may determine the DL-PRS resource(s) based on at least one reference path measurement (e.g., AoA) in the sensing target path profile for detection. Examples of reference measurements may be the measurements made by the WTRU in at least one of the previous occasions (e.g., indicated by the network in terms of measurement or reporting timestamp, measurement configuration ID, reporting configuration ID, or the like).

In another example, the WTRU may receive an association between a sensing target and/or EO with the DL-PRS ID, and the WTRU may determine to measurement the DL-PRS ID(s) based on detecting the sensing target. In another example, the WTRU may receive an indication of a spatial relationship between RSs and determine the DL-PRS ID based on the DL-PRS that is spatially related to the indicated DL-RS ID associated with the sensing target service area.

Regarding a resource based on at least one measurement, in another embodiment, the WTRU may determine the DL-PRS ID(s) based on at least one measurement. The measurements may be the reference measurements (e.g., associated with sensing target and/or EO, or the like) indicated by the network, or the measurements performed by the WTRU in the previous occasion(s) (e.g., associated with a (e.g., indicated) measurement configuration ID and/or reporting configuration ID, or the like).

The WTRU may determine the DL-PRS ID for detection based on the spatial indications by the measurement (e.g., the reference relative delay and/or reference AoA measurement, or the like).

Regarding one or more conditions for detection of sensing target, in one example, the WTRU may determine the sensing target based on the path measurements associated with at least one DL-PRS ID. The WTRU may detect a sensing target based on at least one of the following conditions: at least one measurement of the DL-PRS resource is above or below a (pre)configured threshold; the difference between at least one measurement and the corresponding reference measurement value indicated in the target path profile is above or below a (pre)configured threshold; for example, the WTRU may determine based on the difference between the measured RSRPP measurement of a path and an indicated reference RSRPP value in the assistance information (e.g., of the target path profile) is above a (pre)configured threshold; at least one measurement corresponds to a measurement of the indicated sensing target service area associated with a sensing target (e.g., path with AoA spatially aligned with an indicated detection area (e.g., zone ID, coarse area, reference location, or the like)); the change in at least one measurement (e.g., between two measurement occasions) is above or below a (pre)configured threshold; at least one statistic (e.g., variance, moments, or the like) of the measurement is above or below a (pre)configured threshold, or the like; combinations of the same; or the like.

Also regarding one or more conditions for detection of sensing target, in another embodiment, the WTRU may be configured by the network to detect an EO. The WTRU may detect an EO path based on at least one condition similar to those described for target detection. However, for example, at least one of the preconfigured thresholds or reference measurement values may be associated with the EO profile.

Regarding multiple measurement associated with a detected sensing target or EO, in one embodiment, the WTRU may be configured to associate and/or report at least one or more measurements corresponding to one or more paths with the sensing target and/or an EO. For instance, a large object (e.g., building, a large vehicle, or the like) may contribute to more than one measured multipath component. The WTRU may be configured to determine an association between the paths that may correspond to the same object. For example, the WTRU may be configured to determine the association between the paths that may correspond to the same object based on at least one of the following conditions: the difference between at least one of the measurement(s) between the two detected paths are above or below a (pre)configured threshold; for example, the WTRU may determine that two paths may correspond to the same object if the difference between the relative delay or the AoA for the path(s) is below a (pre)configured threshold; the size of a TO and/or an EO (e.g., detected, indicated by the network, or the like) is above a (pre)configured threshold; the difference between at least one statistic of the detected path measurements is below a (pre)configured threshold; combinations of the same; or the like.

In certain representative embodiments, one or more identifications of a false alarm and/or a missed detection are provided. For example, the one or more identifications of the false alarm and/or the missed detection include at least one of the following: one or more conditions for determination of a false alarm or a missed detection, a determination of a probability of a false alarm and/or a missed detection, an association of false alarm and/or missed detection probabilities with a measurement or (e.g., DL-PRS) configuration, a determination of a probability of a false alarm, a determination of a probability of a missed detection, combinations of the same, or the like.

Regarding one or more conditions for determination of false alarm or missed detection, in one embodiment, the WTRU may be configured by the network to determine and/or report at least one of the events and/or probabilities of false alarm and/or missed detection.

In another embodiment, the WTRU may be configured to determine the event and/or probability of false alarm and/or missed detection. For example, the WTRU may be configured to determine the event and/or probability of the false alarm and/or the missed detection based on at least one of the following trigger conditions: the WTRU receives an indication from the network; the WTRU determines satisfaction of at least one condition associated with detection of a sensing target and/or EO; the difference between at least one measurement associated with a detected sensing target and the corresponding reference EO or sensing target (e.g., different sensing target compared to detected) measurement is above or below a (pre)configured threshold; the difference between at least one measurement associated with a detected EO and the corresponding reference sensing target or an EO (e.g., different EO compared to detected EO) measurement is above or below a (pre)configured threshold; at least one DL-PRS configuration parameter (e.g., bandwidth of the DL-PRS, number of symbols, or the like) is above or below a (pre)configured threshold; at least one property associated with the sensing target and/or EO (e.g., target and/or EO size, velocity, or the like) is above or below a (pre)configured threshold; at least one sensing condition associated with sensing target path profile or EO path profile is not satisfied; the uncertainty associated with at least one measurement of the detected sensing target and/or the EO is above or below a (pre)configured threshold; the WTRU is located in a (pre)configured area associated with determination of false alarm and/or missed detection probabilities; the determined uncertainty or error in the WTRU location and/or WTRU velocity is above or below a (pre)configured threshold; the number of detected sensing target(s) and/or detected EO(s) is above or below a (pre)configured threshold; the number of detected measurement path(s) is above or below a (pre)configured threshold; the measurement is performed within a detection window where the window may be: associated with determination of false alarm and/or missed detection probability, associated with one or more sensing targets (e.g., other than the detected sensing target) and/or one or more EOs (other than the detected EO), or the like; combinations of the same; or the like.

In one embodiment, upon satisfaction of at least one or more of the trigger conditions listed above, the WTRU may determine to request the network for computation of a false alarm or a missed detection probability.

Regarding a determination of probability of a false alarm and a missed detection, and regarding an association of probabilities of the false alarm or the missed detection with a measurement or DL-PRS configuration, in one example, the WTRU may receive a request to determine the false alarm probability and/or missed detection. The WTRU may be configured to determine at least one of the false alarm or missed detection probability. For example, the WTRU may be configured to determine at least one of the false alarm or missed detection probability associated with at least one of the following: associated with at least one measurement (e.g. relative delay, AoA, or the like); associated with a detected path (e.g., sensing target path, EO path, or the like); associated with a detected sensing target (e.g., at least one or a set of detected paths associated with the sensing target); associated with a detected EO (e.g., at least one or a set of detected paths associated with the EO); associated with a spatial region defined by: geographical area, spatial region defined by coverage of DL-PRS beam, spatial region defined by coverage of UL beam, or the like; associated with a time window, or the like; combinations of the same; or the like.

In one embodiment, the WTRU may only identify the measurements associated with at least one of the above-mentioned associated parameters if indicated for determination of the false alarm probability and/or missed detection.

For example, if the WTRU is configured to determine the false alarm probability per measurement (e.g., AoA) of the measured target path, the WTRU may determine to identify at least one of the indicated measurement of the target path for the determination of the probability of false alarm.

Similarly, if the WTRU is indicated to perform the false alarm measurement only within a time window, the WTRU may identify at least one of the measurements within the indicated time window to determine the probability of false alarm.

For example, if the WTRU is configured to determine the probability of missed detection associated with an EO (e.g., via EO ID), the WTRU may identify at least the measurements associated with the EO to determine the missed detection probability.

Regarding a determination of a probability of a false alarm, in one example, the WTRU may be configured to determine the false alarm probability. For example, the WTRU may be configured to determine the false alarm probability based on at least one of the following: at least one configuration parameter, assistance information, combinations of the same, or the like.

Regarding determining the false alarm probability based on at least one configuration parameter, in one embodiment, the WTRU may be configured to determine the false alarm probability based on at least one of the configuration parameters associated with the detection of the target path. The probability of false alarm may arise from insufficient resolution associated with the measurements due to configuration. For example, the WTRU may determine the false alarm probability based on at least one of the following: the resolution in time domain measurement determined by at least one of the DL-PRS configuration parameters such as DL-PRS bandwidth, number of DL-PRS symbols, DL-PRS frequency density (e.g., comb pattern), or the like; the resolution in angular domain measurement determined by at least one of the DL-PRS configuration parameters such as number of WTRU antenna ports, number of DL-PRS symbols, DL-PRS frequency density (e.g., comb pattern), or the like; the sensing delay range (e.g., associated with each measured DL-PRS beam) defined by DL-PRS configuration parameters such as the subcarrier spacing or cyclic prefix length associated with the measured DL-PRS; the sensing angular range (e.g., associated with the measured DL-PRS beam) defined by the directions and the beamwidths of the measured DL-PRS beam, or the like; the resolution between the measurements, determined by at least one of the configuration parameters such as DL-PRS periodicity; combinations of the same; or the like.

For example, the WTRU may associate a higher resolution in time and/or angular domain measurement (e.g., depending on the measurements performed for target detection) with a lower false alarm probability and vice-versa. The higher resolution in time and/or angular domain measurement may increase the confidence in measurement.

For example, the WTRU may associate a smaller delay and/or angular range with a lower false alarm probability as it may reduce the measured noise (e.g., measurements associated with clutters, interference, or the like) and hence improving the confidence in the measurement. The WTRU may determine a higher false alarm probability otherwise.

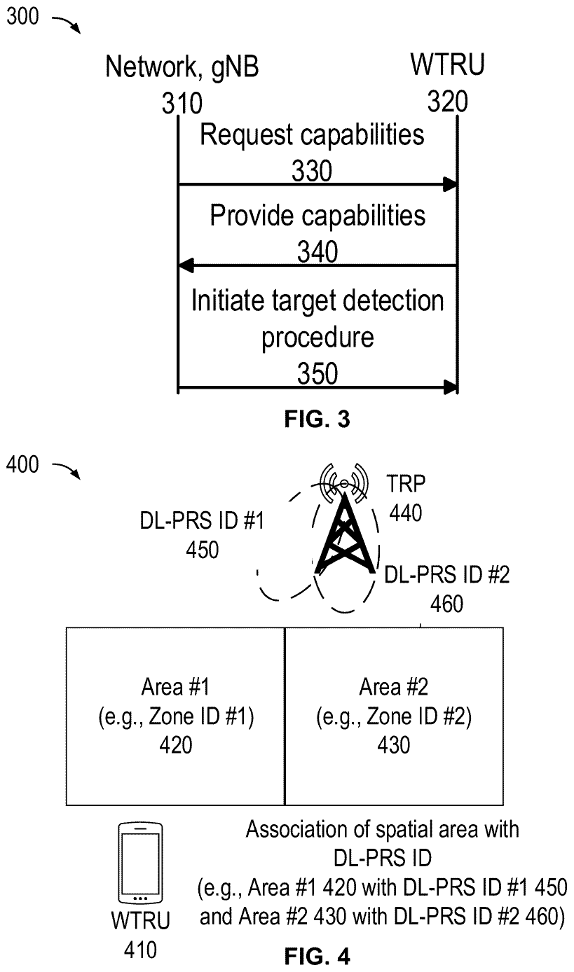

An example of association of the sensing delay range and subcarrier spacing and hence the cyclic prefix (CP) length is illustrated in FIG. 6. As shown in FIG. 6, communications between a WTRU 610 and a TRP 620 occur within (e.g., PRS) subcarrier spacing #1 650 (represented by the inner oval) and within (e.g., PRS) subcarrier spacing #2 660 (represented by the outer oval). A sensing delay range 1 630 occurs between the WTRU 610 and the TRP 620 within the subcarrier spacing #1 650. A sensing delay range 2 640 occurs between the WTRU 610 and the TRP 620 within the subcarrier spacing #2 660.

For example, the sensing range corresponding to the subcarrier spacing #1 650 (e.g., 30 kHz) is different compared to the sensing range corresponding to the subcarrier spacing #2 660 (e.g., 15 kHz). The CP, in one example, may define the maximum sensing delay range which the WTRU 610 may be able to unambiguously measure. Hence, the maximum sensing delay range in one example, may be defined by the CP duration. Likewise, the WTRU 610 may determine different noise levels to the sensing measurement based on different sensing delay range, and hence the WTRU may determine the false alarm probability based on the sensing delay range.

Regarding determining the false alarm probability based on assistance information, in another embodiment, the WTRU may be configured to determine the probability of false alarm based on at least one of assistance information indicated by the network. For example, the WTRU may be configured to determine the probability of false alarm based on at least one of a sensing target path profile, an EO path profile, one or more measurements, a WTRU state, combinations of the same, or the like.

Regarding the WTRU configured to determine the probability of false alarm based on a sensing target path profile, in one embodiment, the WTRU may determine the probability of false alarm based on at least one assistance information indicated in the target path profile. For example, the at least one assistance information includes at least one of a sensing target property, a reference measurement associated with a sensing path profile, one or more statistics associated with a reference measurement, combinations of the same, or the like.

Regarding a sensing target property, for example, the WTRU may determine the false alarm probability based on the sensing target type. Some sensing targets may have distinct properties (e.g., target size, target velocity, reference measurement associated with the targets, or the like) such that they can be easily detected.

For example, a sensing target such as a large vehicle (e.g., trucks) may be detected with a lower false alarm probability due to their size compared to a smaller sensing target (e.g., a relatively small UAV).

Likewise, a sensing target with higher velocity (e.g., vehicles) may be associated with a larger false alarm probability compared to a static target or a target with lower velocity (e.g., a human).

In one embodiment, the WTRU may be configured with the prior probability for a false alarm indicating the likelihood of false alarm associated with each sensing target. The WTRU may identify at least one of the prior probabilities associated with the sensing target type for the computation of a false alarm.

In another embodiment, the WTRU may be indicated with a prior probability associated with at least one measurement, at least one path, at least one DL-PRS, at least one TRP, at least one cell, or the like, and the WTRU may determine to use the prior information to determine the probability of false alarm.

Regarding a reference measurement associated with sensing path profile, for example, the WTRU may determine the false alarm based on at least one of the reference measurements indicated by the network associated with the sensing target. For instance, the WTRU may determine the false alarm probability based on the difference between at least one measurement performed by the WTRU (e.g., associated with the detected sensing target) and the corresponding reference measurement associated with the sensing target path (e.g., indicated in the sensing target path profile).

For example, the WTRU may determine a large false alarm probability if the difference in at least one or more measurements between the detected path and the corresponding reference measurement in the sensing path profile is above a (pre)configured threshold, and a small false alarm probability otherwise.

Regarding statistics associated with the reference measurement, in one example, the WTRU may determine the false alarm probability based on the statistics associated with the sensing target path profile. Examples of the statistics associated with the sensing path profile may include at least one of the following: distribution associated with the reference measurement of the sensing target (e.g., normal distribution, uniform distribution, or the like); moments of the reference measurement of the sensing target (e.g., mean, variance, or the like); any other parameters required to define the distribution (e.g., minimum and maximum value of the measurements, or the like); combinations of the same; or the like.

In one embodiment, the WTRU may determine the false alarm probability based on the determined probability that the measurement belongs to the distribution.

An example false alarm probability may be a determination of the probability density of at least one measurement under the sensing target distribution function.

Regarding the WTRU configured to determine the probability of false alarm based on an EO path profile, in another embodiment, the WTRU may be configured to determine the false alarm probability based on at least one of the assistance information indicated by the network in the EO path profile. For example, the at least one assistance information includes at least one of an EO property, a reference measurement associated with an EO path profile, statistics associated with an EO measurement, combinations of the same, or the like.

Regarding an EO property, in one embodiment, the WTRU may be configured to determine the false alarm probability based on at least one of the EO properties (e.g., indicated in the EO path profile).

For example, the WTRU may determine a large false alarm probability if the difference between at least one sensing target property and one EO property is below a (pre)configured threshold, and a small probability otherwise. An example of this may be the target and an EO size. If the size and/or the material of the target and the EO are similar, the WTRU may determine that the false alarm probability may be large.

In another example, the WTRU may be configured with the prior probability for false alarm indicating the likelihood of false alarm associated with each EO. The WTRU may be configured to determine the false alarm based on prior probabilities associated with an EO. One example of the prior probability may be in terms of the density of EO indicated by the network.

In another example, the WTRU may be configured with the prior probability of an EO, e.g., associated with at least one measurement, at least one path, at least one DL-PRS, at least one TRP, at least one cell, or the like, and the WTRU may determine to use the prior information to determine the probability of false alarm.

Regarding a reference measurement associated with EO path profile, in one example, the WTRU may be configured to determine the false alarm based on at least one of the reference measurements indicated by the network associated with the EO. For instance, the WTRU may determine the false alarm probability based on the difference between at least one measurement performed by the WTRU (e.g., associated with the detected sensing target) and the corresponding reference measurement associated with an EO.

For example, the WTRU may determine a large false alarm probability if the difference in at least one or more measurements between the detected path and the corresponding reference measurement in the EO path profile is above a (pre)configured threshold, and a small false alarm probability otherwise.

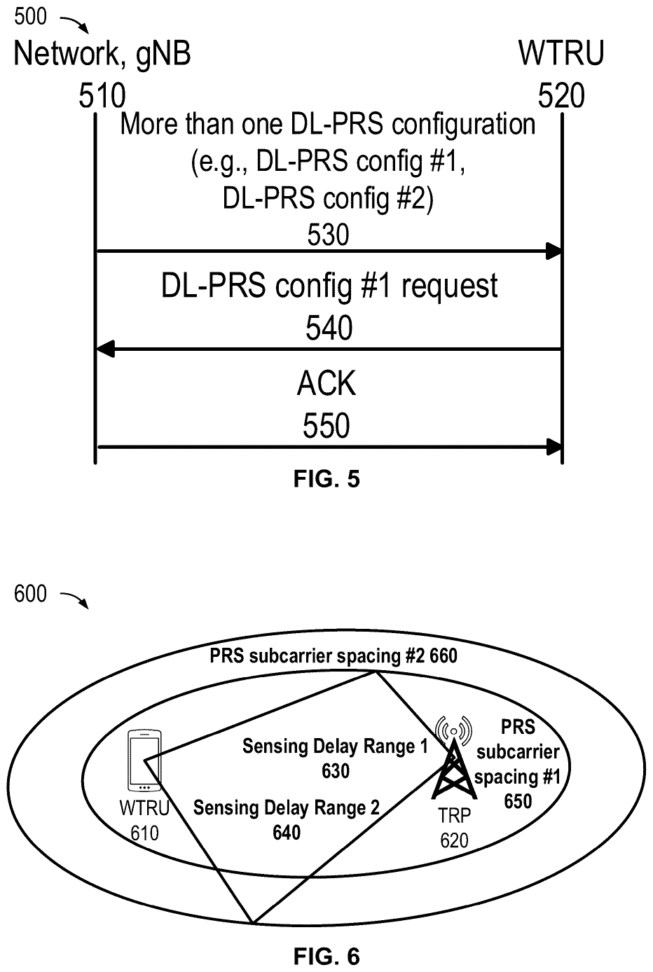

FIGS. 7A and 7B illustrate examples of the probability of a false alarm determination based on the difference in measurements between EO and target path profiles. FIG. 7A is a chart 700 of RSRPP (on the y-axis) versus relative delay (on the x-axis). Details of FIG. 7A are provided after the description of FIG. 7B.

FIG. 7B illustrates an environment 750 in which a WTRU 760 is in communication with a TRP 790. The environment 750 includes an EO 770 and a sensing target 780. An LoS path 760a occurs between the WTRU 760 and the TRP 790. On the left side of FIG. 7B, three reflection paths, 770a, 770b, 770c, are shown between the WTRU 760 and the TRP 790, where each path is incident with the EO 770. On the right side of FIG. 7B, a reflection path 780a is shown between the WTRU 760 and the TRP 790, where the reflection path 780a is incident with the sensing target 780.

In FIG. 7A, the first arrow corresponds with the RSRPP of the reference Los path 760a, the second arrow corresponds with the RSRPP of the path 780a, the third and fifth arrows correspond with the RSRPP of the paths 770b, 770c, respectively, and the fourth arrow corresponds with the RSRPP of the path 770a. Since the RSRPP of the path 780a falls within the target relative delay profile (along the x-axis) and within the target RSRPP profile (along the y-axis), the RSRPP of the path 780a indicates a relatively low probability of false alarm (FA). Whereas, since the RSRPP of the path 770a falls within the EO relative delay profile (along the x-axis) and despite being within the target RSRPP profile (along the y-axis), the RSRPP of the path 770a indicates a relatively high probability of false alarm (FA). Also, since the RSRPPs of the paths 770b, 770c fall within the EO relative delay profile (along the x-axis) and within the EO RSRPP profile (along the y-axis), the RSRPPs of the paths 770b, 770c indicate correspondence with an EO target.

That is, the WTRU 760 may detect a path 770a corresponding to the EO 770 as a detected target path based on RSRPP measurement falling in the target reference RSRPP value range (see, FIG. 7A). However, based on relative delay measurement being within the reference EO relative range value, the WTRU 760 may determine to associate a high false alarm probability to the path 770a. In comparison, since the path 780a associated with the sensing target 780 is within the target relative delay profile and the target RSRPP profile, the WTRU 760 may determine a low false alarm probability to the path 780a.

Regarding statistics associated with the EO measurement, in one example, the WTRU may determine the false alarm probability based on the statistics associated with the reference measurements in the EO path profile. Examples of the statistics associated with the sensing path profile may include at least one of the following: distribution associated with the reference measurement of the EO (e.g., normal distribution, uniform distribution, or the like); moments of the reference measurement of the EO (e.g., mean, variance, or the like); any other parameters required to define the distribution (e.g., minimum and maximum value of the measurements, or the like); combinations of the same; or the like.

In one embodiment, the WTRU may determine the false alarm probability based on the determined probability that the measurement belongs to the distribution.

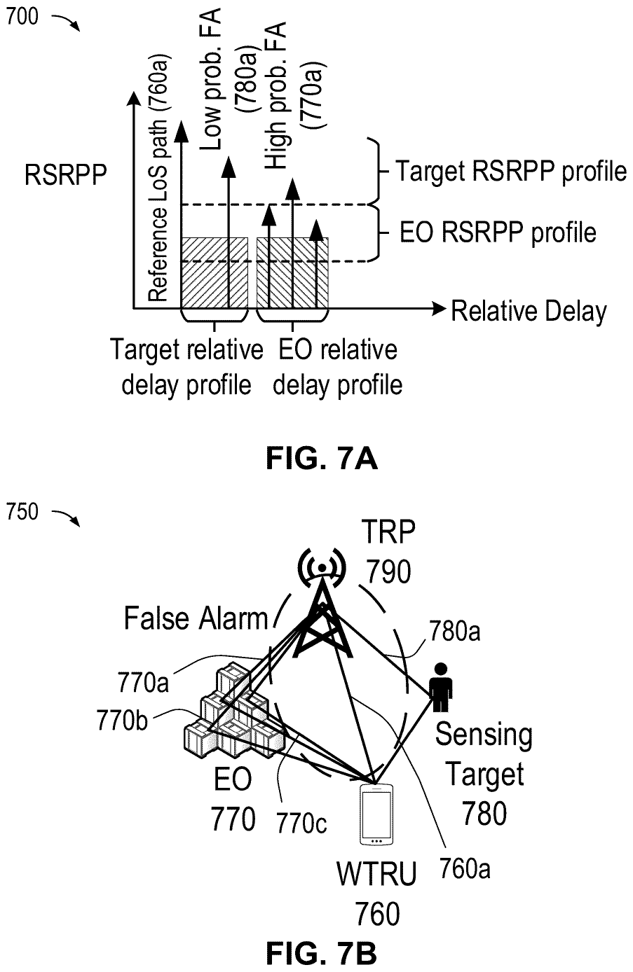

As illustrated in a chart 800 in FIG. 8, an example of a determination of a false alarm probability is provided. The chart includes a Target distribution of a measurement profile of the Target (e.g., doppler shift, along the x-axis) and an EO distribution of a measurement profile of the EO (e.g., again, doppler shift). For example, a determination is made of the probability (y-axis) or the density that the at least one measurement (indicated by the dashed line in FIG. 8 labeled “Measured value”) corresponds to a sensing path (e.g., doppler shift measurement), which arises from the probability distribution corresponding to the doppler shift measurement (indicated by the portion of the dashed line in FIG. 8 below the EO distribution).

Another example of a determination of the probability of false alarm may be based on the following procedure:

Given an observation (e.g., measurement) z, and distributions for a sensing target measurement

$${H}_{T} \to z comes from T \qquad ( 2 )$$

$${H}_{EO} \to z comes from EO \qquad ( 3 )$$

and an EO measurement

$$EO ∼ N ( {μ}_{EO} , {σ}_{EO}^{2} ) .$$

Consider two hypothesis, equations (2) and (3), as follows:

$$( T ) T ∼ N ( {μ}_{T} , {σ}_{T}^{2} )$$

The false alarm probability P(H_{EO}|z) can be based on Bayes equations (4) and (5), as follows:

$$P ( {H}_{EO} \vert z ) = \frac{P ( z \vert {H}_{EO} ) P ( {H}_{EO} )}{P ( z )} = \frac{P ( z \vert {H}_{EO} ) P ( {H}_{EO} )}{P ( z \vert {H}_{EO} ) P ( {H}_{EO} ) + P ( z \vert {H}_{T} ) P ( {H}_{T} )} \qquad ( 4 )$$

Assuming equal prior probability of EO and target, or P(H_{EO})=P(H_{T})=0.5,

$$P ( {H}_{EO} \vert z ) = \frac{P ( z \vert {H}_{EO} )}{P ( z )} = \frac{P ( z \vert {H}_{EO} )}{P ( z \vert {H}_{EO} ) + P ( z \vert {H}_{T} )} \qquad ( 5 )$$

P(z|H_{EO})→Density of z under

$$N ( {μ}_{EO} , {σ}_{EO}^{2} )$$

and P(z|H_{T})→Density of z under

$$N ( {μ}_{T} , {σ}_{T}^{2} ) /$$

Hence, the probability of false alarm may be determined by determination of the probability density of the EO hypothesis that the measurement z arises from the probability density of H_{EO}.

In the above example, the prior probabilities for the sensing target and EO were considered as equal, i.e., 0.5 and 0.5, however, in one embodiment, the WTRU may determine the probability of false alarm based on the prior probability.

Regarding the WTRU configured to determine the probability of false alarm based on one or more measurements, in one example, the WTRU may be configured to determine the false alarm probability. For example, the WTRU may be configured to determine the false alarm probability based on at least one of the following: at least one measurement, the change between at least one measurement (e.g., in two measurement occasions), at least one statistic (e.g., variance) of at least one measurement, the determined uncertainty associated with at least one measurement, the number of detected paths associated with the detected sensing target, the number of detected paths associated with the detected EO, the number of detected sensing targets, the number of detected EO, the distance between the target and a location (e.g., center) in the indicated detection area, the number of samples associated with at least one measurement of the detected path, the measurement corresponding to clutter (e.g., RSRPP, RSRP, or the like) or noise, the determination of reference (e.g., reference path such as LoS path) in the measurement, combinations of the same, or the like.

Regarding the WTRU configured to determine the probability of false alarm based on WTRU state, the WTRU may be configured to determine the false alarm probability based on at least one of the following: WTRU location, change in WTRU location (e.g., in two measurement occasions), the estimated error in WTRU location, the determined velocity of the WTRU, the estimated error in WTRU velocity, the change between the WTRU velocity (e.g., in two measurement occasions), combinations of the same, or the like.

In one embodiment, the WTRU may be configured to use at least one or a combination of the above-mentioned factors to determine the probability of the false alarm.

Regarding determination of probability of missed detection, in one embodiment, the WTRU may be configured to determine the probability of missed detection. For example, the WTRU may be configured to determine the probability of missed detection based on at least one of the following: configuration parameters, at least one assistance information indicator, an EO path profile, a target path profile, one or more measurements, a UE state, combinations of the same, or the like.

Regarding the WTRU configured to determine the probability of missed detection based on configuration parameters, in one embodiment, the WTRU may be configured to determine the missed based on at least one of the DL-PRS configuration parameters.

For example, the resolution in time domain measurement may be determined by at least one of the DL-PRS configuration parameters such as DL-PRS bandwidth, number of DL-PRS symbols, DL-PRS frequency density (e.g., comb pattern), or the like.

For example, the resolution in angular domain measurement may be determined by at least one of the DL-PRS configuration parameters such as number of WTRU antenna ports, number of DL-PRS symbols, DL-PRS frequency density (e.g., comb pattern), or the like.

For example, the sensing delay range (e.g., associated with each measured DL-PRS beam) may be defined by DL-PRS configuration parameters such as the subcarrier spacing or cyclic prefix length associated with the measured DL-PRS.

For example, the sensing angular range (e.g., associated with the measured DL-PRS beam) may be defined by the directions and the beamwidths of the measured DL-PRS beam, or the like.

For example, the resolution between the measurements may be determined by at least one of the configuration parameters such as DL-PRS periodicity.

Regarding the WTRU configured to determine the probability of missed detection based on at least one assistance information, in another embodiment, the WTRU may be configured to determine the probability of missed detection based on at least one of the assistance information indicated by the network.

Regarding the WTRU configured to determine the probability of missed detection based on EO path profile, on one embodiment, the WTRU may determine the probability of missed detection based on at least one assistance information indicated in the target path profile. For example, the WTRU may determine the probability of missed detection based on at least one of an EO property, a reference measurement associated with the EO path profile, one or more statistics associated with reference EO measurements, combinations of the same, or the like.

For example, regarding an EO property, the WTRU may determine the missed detection probability based on at least one property of an EO (e.g., indicated EO, detected EO, or the like).

For example, the WTRU may determine the missed detection probability based on at least one of the following: the determined size of at least one EO is above a (pre)configured threshold, the determined velocity of at least one EO is above or below a (pre)configured threshold, the prior probability of at least one EO (e.g., indicated the EO path profile) is above a (pre)configured threshold, combinations of the same, or the like.

For example, regarding a reference measurement associated with EO path profile, the WTRU may determine the missed detection probability if the difference between at least one measurement performed by the WTRU (e.g., associated with the detected EO) and the corresponding reference measurement associated with the EO path profile is above or below a (pre)configured threshold.

Regarding statistics associated with the reference EO measurement, in one example, the WTRU may determine the missed detection probability based on the statistics associated with the EO path profile. The WTRU may determine the missed detection probability based on the determined probability that at least one indicated statistic (e.g., variance), for instance, associated with an EO, is above or below a (pre)configured threshold.

Regarding the WTRU configured to determine the probability of missed detection based on target path profile, in one embodiment, the WTRU may determine the probability of missed detection based on at least one assistance information indicated in the target path profile. For example, the WTRU may determine the probability of missed detection based on at least one of a sensing target property, a reference measurement associated with a sensing path profile, one or more statistics associated with a reference measurement in a sensing path profile, combinations of the same, or the like.

Regarding a sensing target property, in one embodiment, the WTRU may determine the probability of missed detection based on determining that the difference between at least one property in the sensing target profile and at least one EO (e.g., detected EO) is above or below a (pre)configured threshold. For instance, the WTRU may determine a large, missed detection probability if the difference between determined size and/or velocity of an EO and a (e.g., indicated, detected) sensing target is above or below a (pre)configured threshold.

For example, regarding a reference measurement associated with a sensing path profile, the WTRU may determine the probability of missed detection based on at least one of the reference measurements indicated by the network associated with the sensing target. For instance, the WTRU may determine the missed detection probability based on the difference between at least one measurement performed by the WTRU (e.g., associated with the detected EO) and the corresponding reference measurement associated with the target path. The WTRU may determine a large, missed detection probability if the difference in at least one or more measurements between the detected EO path and the corresponding reference measurement in the sensing path profile is below a (pre)configured threshold, and a small, missed detection probability otherwise.

Regarding statistics associated with the reference measurement in the sensing path profile, in one example, the WTRU may determine the missed detection probability based on the statistics associated with the sensing target path profile. In one embodiment, the WTRU may determine the false alarm probability if at least one statistic (e.g., variance) of the sensing target measurement is above or below a (pre)configured threshold.

Regarding the WTRU configured to determine the probability of missed detection based on measurements, in one example, the WTRU may be configured to determine the missed detection probability based on at least one of the conditions based on measurement defined for determination probability of false alarm.

Regarding the WTRU configured to determine the probability of missed detection based on WTRU state, in one example, the WTRU may be configured to determine the missed detection probability based on at least one of the conditions based on WTRU state defined for determination of a probability of false alarm by replacing the term “false alarm” with “missed detection.”

In the above examples, the WTRU may receive an indication of at least one factor or method to determine the probabilities of false alarms or missed detections. In another example, the WTRU may be configured to determine and report at least one factor and/or based on which the WTRU determined the false alarm probability.

In another example, the WTRU may determine the false alarm or the missed detection probability based on more than one measurement occasion as accurate evaluation may depend on multiple samples. The WTRU may be configured to determine the probabilities or events in multiple instances based on averaging (e.g., mean, median, or the like).

In certain representative embodiments, reporting is provided. For example, the WTRU may be configured to report a detection of at least one sensing target and/or an EO and/or sensing measurements to the network.

In one embodiment, the WTRU may be configured with conditional reporting. For example, the WTRU may report based on at least one of the following conditions: the WTRU detects at least one path (e.g., associated with sensing target and or EO); the WTRU detects at least one sensing target and/or at least one EO; the determined probability of false alarm (e.g., associated with at least one measured path, DL-PRS ID, or the like) is above or below a (pre)configured threshold; the determined probability of false alarm (e.g., associated with at least one measured path, DL-PRS ID, or the like) is above or below a (pre)configured threshold; the number of false alarm events is above or below a (pre)configured threshold; the number of missed detection events are above or below a (pre)configured threshold; at least one measurement (e.g., associated with the detected sensing target and/or EO) is above or below a (pre)configured threshold; the difference between at least one measurement (e.g., between measurement occasions, e.g., associated with the detected sensing target and/or detected EO) is above or below a (pre)configured threshold; at least one statistic (e.g., variance, moments, or the like) associated with at least one measurement (e.g., of the detected sensing target or detected EO) is above or below a (pre)configured threshold; combinations of the same; or the like.

In another example, the WTRU may be configured with periodic reporting. The WTRU may report the detection information to the network periodically based on the configured periodicity.

In one example, the WTRU may be configured to report at least one of the following: at least one detected target (e.g., target ID); at least one detected EO (e.g., EO ID); at least one measurement associated with the detected target; at least one measurement associated with detected EO; at least one false alarm probability (e.g., associated with at least one path, DL-PRS ID, target ID, EO ID, detection window, or the like); at least one missed detection probability (e.g., associated with at least one path, DL-PRS ID, target ID, EO ID, detection window, or the like); at least one condition in the conditional reporting that triggered the measurement report; at least one factor based on which the probabilities of false alarm and/or missed detection was determined; at least one factor considered to determine the missed detection and/or false alarm probability; at least one measurement (e.g., not associated with the sensing target and/or EO); uncertainty in at least one measurement; WTRU location and/or the associated uncertainty in WTRU location; WTRU velocity and/or the associated uncertainty in WTRU velocity; time stamp associated with at least one measurement, WTRU location, WTRU velocity, target detection, EO detection, or the like, e.g., in time index units; at least one path measurement (e.g., not associated with detected target or EO); at least one clutter measurement (e.g., RSRP associated with paths not associated with detected target and/or EO); DL-PRS ID (e.g., DL-PRS resource ID, DL-PRS beam ID, DL-PRS resource set ID, TRP ID, cell ID, or the like) associated with the measurements; combinations of the same; or the like.

In certain representative embodiments, subsequent WTRU behavior is provided. In one example, the WTRU may be configured to request a second set of configurations from the network based on the determination of false alarm and/or missed detection.

In one embodiment, the WTRU may be configured to determine and request the DL-PRS configuration if the WTRU determines at least one of the conditions defined for conditional reporting (as defined earlier) is satisfied.

In one embodiment, the WTRU may determine to request for a first DL-PRS configuration for target detection if at least one of the conditions associated with the conditional reporting is satisfied and a second DL-PRS configuration otherwise.

In one example, the WTRU may determine that the false alarm and/or missed detection is caused due to low time and/or angular resolution. The WTRU may request for DL-PRS with first configuration parameters including least one of the following: a first DL-PRS bandwidth; a first DL-PRS comb pattern and/or a first comb size (e.g., for adjustment of DL-PRS density in frequency domain); a first number of DL-PRS symbols; combinations of the same; or the like. The WTRU may determine to request a second configuration parameter otherwise.

In another example, the WTRU may determine the false alarm and/or missed detection is caused due to sensing angular range. The WTRU may determine to request for a DL-PRS with first configuration parameters including at least one of the following: a first sequence of DL-PRS beams (e.g., DL-PRS beam ID(s)); in one example, the WTRU may determine to request for DL-PRS resource(s) with narrower or wider angular coverage defined by the number of total number of (e.g., spatially orthogonal beams) beams; a first DL-PRS resource set (e.g., DL-PRS resource set ID); in one example, the WTRU may determine to request the DL-PRS resource set ID with a first beamwidth based on the probabilities of false alarm and/or missed detection; combinations of the same; or the like. The WTRU may determine to request the DL-PRS configuration with the second configuration parameter otherwise.

In another example, the WTRU may determine that the false alarm and/or missed detection may be caused due to sensing delay resolution. The WTRU may determine to request a DL-PRS configuration with first configuration parameters including at least one of the following upon satisfaction of at least one of the conditional reporting conditions: a DL-PRS configuration or a bandwidth part (BWP) configuration with a first sub-carrier spacing and/or a first cyclic prefix; a DL-PRS configuration with a first transmission power value; combinations of the same; or the like. The WTRU may determine to request the configuration with a second configuration parameter otherwise.

In another example, the WTRU may determine that the probability of false alarm and/or missed detection associated with at least one geographical area may be above or below a (pre)configured threshold. The WTRU may determine to request for a DL-PRS with first configuration parameters including at least one of the following if at least one of the conditional reporting conditions are satisfied: a first DL-PRS beam spatially aligned or not aligned with the geographical area; a first DL-PRS resource set (e.g., DL-PRS beamwidth); a first DL-PRS periodicity; combinations of the same; or the like. The WTRU may determine to request the configuration with a second configuration parameter otherwise.

In another embodiment, the WTRU may be configured to request a first DL-PRS measurement configuration if at least one of the conditions associated with the conditional reporting is satisfied and a second DL-PRS measurement configuration otherwise.

The WTRU may be configured to request to measure a first quantity (e.g., time-based measurement such as relative delay measurement, angle based measurement such as AoA, AoD, phase based measurement, or the like) if at least one of the following conditions are satisfied: the probability of false alarm and/or missed detection associated with at least one of the measurement quantities is above or below a (pre)configured threshold; the uncertainty associated with at least one of the measurement quantities is above or below a (pre)configured threshold; at least one of the DL-PRS configuration parameter (e.g., bandwidth) is above or below a (pre)configured threshold; at least one of the WTRU state parameters (e.g., WTRU velocity, number of WTRU antenna elements, or the like) is above or below a (pre)configured threshold; the WTRU is located in a geographical location associated with a measurement quantity; combinations of the same; or the like.

In another embodiment, the WTRU may be configured to request a first DL-PRS reporting configuration if at least one of the conditions associated with the conditional reporting is satisfied and a second DL-PRS measurement configuration otherwise.

In one example, the WTRU may determine a periodic reporting configuration if at least one of the conditional reporting conditions are satisfied and event-triggered reporting otherwise. For example, the WTRU may request for a periodic reporting if the probability of false alarm is above a (pre)configured threshold.

In one example, the WTRU may determine the reporting intervals, periodicity (e.g., for periodic measurement report), or the like if at least one of the conditional reporting conditions are satisfied. For example, the WTRU may determine to request a first DL-PRS reporting periodicity if the probability of false alarm is above a (pre)configured threshold and a second otherwise.

In one embodiment, the WTRU may be configured with more than one DL-PRS configuration, measurement configuration and/or reporting configuration (e.g., DL configuration ID(s), measurement configuration ID(s), reporting configuration ID(s), or the like). The WTRU may determine the best configuration based on the defined conditions and request, e.g., from the network, activation of one or more configuration if the conditions are satisfied.

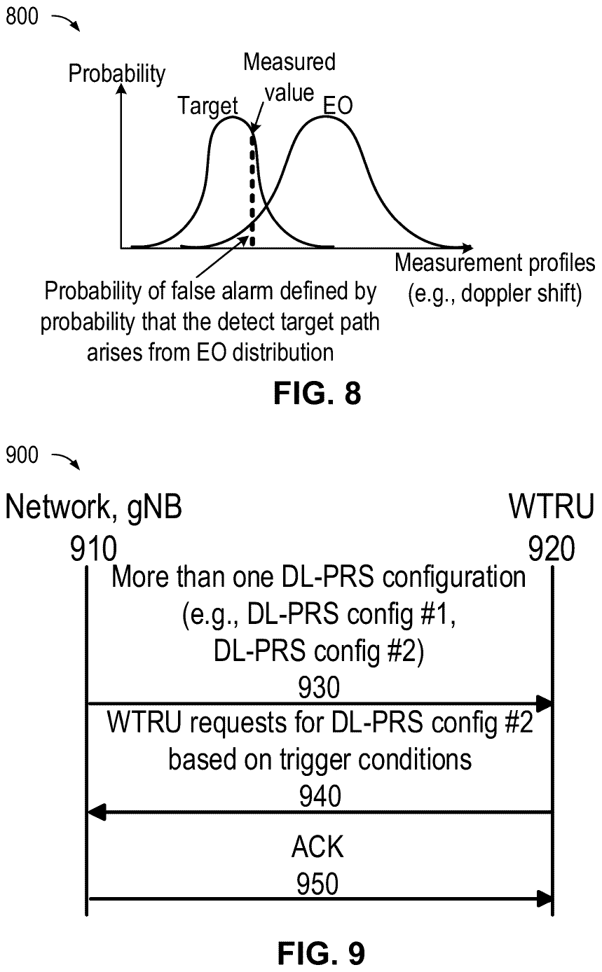

FIG. 9 shows a diagram illustrating a WTRU requesting a configuration for target detection, according to one or more embodiments. In diagram 900, at 930, a network (e.g., gNB) 910 (which may be the same as any of previously mentioned gNBs 180a-180c, or the like) transmits more than one DL-PRS configuration (e.g., DL-PRS config #1, DL-PRS config #2, or the like) to a WTRU 920 (which may be the same as any of previously mentioned WTRUs 102a-102d or 205, or the like). At 940, the WTRU 920 requests a DL-PRS config #2 from the gNB 910, which may be based on one or more trigger conditions. At 950, the gNB 910 transmits an ACK message to the WTRU 920.

In another embodiment, the WTRU may be configured with at least one (e.g., on-demand) DL-PRS configuration, measurement configuration and/or reporting configuration. The WTRU may determine the best configuration based on the conditions and request for activation of at least of the on-demand configurations if the conditions are satisfied.

In another embodiment, the WTRU may request the configuration parameters to the network based on the conditions.

In one embodiment, the WTRU may receive a second configuration based on the request. The WTRU may receive the configuration indication for the second configuration by an ACK or NACK message or the indication of configuration index, or the like.

In another embodiment, the WTRU may be configured to terminate the detection procedure if at least one of the conditional reporting conditions is satisfied.

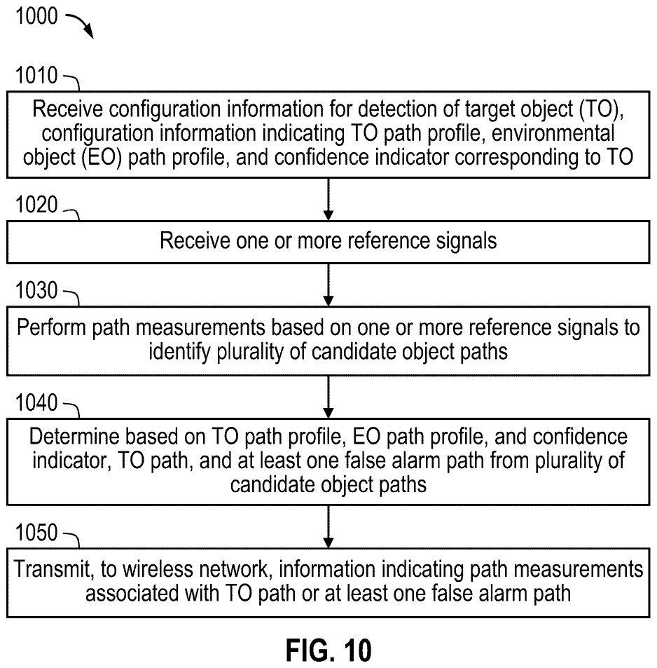

In certain representative embodiments, as shown in FIG. 10, a method is performed by a WTRU (e.g., 102, 205, 320, 410, 520, 610, 760, 920). For example, the method includes at least one of the following: at 1010, receiving configuration information for detection of a TO (e.g., 215, 780), the configuration information indicating a TO path profile, an EO path profile (e.g., of an EO, e.g., 210, 770), and a confidence indicator corresponding to the TO; at 1020, receiving one or more reference signals (e.g., DL-PRS, SRSp, CSI-RS, DM-RS, SSB, or the like); at 1030, performing path measurements (e.g., one or more RSRPP measurement(s), one or more AoA (e.g., per path) measurement(s), one or more relative delay measurement(s), one or more delay spread measurement(s), one or more RCS, one or more micro-doppler measurement(s), one or more carrier-phase (e.g., per path) measurement(s), one or more doppler shift (e.g., per path) measurement(s), one or more doppler spread measurement(s), combinations of the same, or the like) based on the one or more reference signals to identify a plurality of candidate object paths (e.g., 230a/235a/240a; 770a/770b/770c/780a; or the like); at 1040, determining based on the TO path profile, the EO path profile, and the confidence indicator, (1) a TO path (e.g., 230a, 780a), and (2) at least one false alarm path (e.g., 770a) from the plurality of candidate object paths; at 1050, transmitting, to a wireless network (e.g., 106, 115, TRP 220, gNB 310, TRP 440, gNB 510, TRP 620, TRP 790, gNB 910), any of information indicating path measurements, of the path measurements, associated with (1) the TO path, or (2) the at least one false alarm path; combinations of the same; or the like.

Also, for example, the confidence indicator comprises a threshold. Further, for example, the determining (1) the TO path comprises determining that a difference between at least one of the path measurements and a corresponding measurement value in the TO path profile is below the threshold. In addition, for example, the configuration information comprises a false alarm threshold. Moreover, for example, the determining (2) the at least one false alarm path comprises determining that a probability of a false alarm for at least one of the candidate object paths and a corresponding EO measurement value in the EO path profile is above the false alarm threshold. Furthermore, for example, the path measurements comprise at least one of RSRP, RSRPP, delay, relative delay, AoA, doppler shift, delay spread, doppler spread, RSTD, WTRU reception-transmission time difference, RSCP measurement, RSCPP, RSCPD measurement, RSCPD measurement per path, RCS, micro-doppler measurement, combinations of the same, or the like. Additionally, for example, each of the TO path profile and the EO path profile comprises at least one statistic associated with a reference TO measurement value and a reference EO measurement value, respectively. Still further, for example, the at least one statistic comprises at least one of a mean or a variance. Even further, for example, the determining (2) the at least one false alarm path comprises determination of a confidence value associated with the false alarm path. Yet further, for example, the information (e.g., transmitted to the wireless network) further indicates the confidence value.

In some embodiments, the configuration information comprises a DL-PRS configuration. For example, the WTRU performs the path measurements based on the DL-PRS configuration and received resources of the DL-PRS. Also, for example, the DL-PRS configuration indicates to the WTRU to determine and report a false alarm probability of the detected TO. Further, for example, resources of the DL-PRS comprise a beam sweeping pattern.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU), the method comprising:
receiving configuration information for detection of a target object (TO), the configuration information indicating a TO path profile, an environmental object (EO) path profile, and a confidence indicator corresponding to the TO;
receiving one or more reference signals;
performing path measurements based on the one or more reference signals to identify a plurality of candidate object paths;
determining, based on the TO path profile, the EO path profile, and the confidence indicator, (1) a TO path and (2) at least one false alarm path from the plurality of candidate object paths; and
transmitting, to a wireless network, information indicating path measurements associated with (1) the TO path, or (2) the at least one false alarm path.

2. The method of claim 1, wherein:
the confidence indicator comprises a threshold; and
the determining the TO path comprises determining that a difference between at least one of the path measurements and a corresponding measurement value in the TO path profile is below the threshold.

3. The method of claim 1, wherein:
the configuration information comprises a false alarm threshold; and
the determining the at least one false alarm path comprises determining that a probability of a false alarm for at least one of the candidate object paths and a corresponding EO measurement value in the EO path profile is above the false alarm threshold.

4. The method of claim 1, wherein the configuration information comprises a downlink positioning reference signal (DL-PRS) configuration.

5. The method of claim 4, wherein the WTRU performs the path measurements based on the DL-PRS configuration and received resources of the DL-PRS.

6. The method of claim 4, wherein the DL-PRS configuration indicates to the WTRU to determine and report a false alarm probability of the detected TO.

7. The method of claim 4, wherein resources of the DL-PRS comprise a beam sweeping pattern.

8. The method of claim 1, wherein the path measurements comprise at least one of reference signal received power (RSRP), RSRP per path (RSRPP), delay, relative delay, angle of arrival (AoA), doppler shift, delay spread, doppler spread, reference signal time difference (RSTD), WTRU reception-transmission time difference, reference signal carrier phase (RSCP) measurement, RSCP per path (RSCPP), RSCP difference (RSCPD) measurement, RSCPD measurement per path, radar cross section (RCS), or micro-doppler measurement.

9. The method of claim 1, wherein:
each of the TO path profile and the EO path profile comprises at least one statistic associated with a reference TO measurement value and a reference EO measurement value, respectively; and
the at least one statistic comprises at least one of a mean or a variance.

10. The method of claim 1, wherein:
the determining the at least one false alarm path comprises determination of a confidence value associated with the false alarm path; and
the information further indicates the confidence value.

11. A wireless transmit/receive unit (WTRU) comprising:
a processor; and
a transceiver coupled to the processor, wherein the WTRU is to:
receive configuration information for detection of a target object (TO), the configuration information indicating a TO path profile, an environmental object (EO) path profile, and a confidence indicator corresponding to the TO;
receive one or more reference signals;
perform path measurements based on the one or more reference signals to identify a plurality of candidate object paths;
determine based on the TO path profile, the EO path profile, and the confidence indicator, (1) a TO path, and (2) at least one false alarm path from the plurality of candidate object paths; and
transmit, to a wireless network, information indicating path measurements associated with (1) the TO path, or (2) the at least one false alarm path.

12. The system of claim 11, wherein:
the confidence indicator comprises a threshold; and
the WTRU to determine the TO path further determines that a difference between at least one of the path measurements and a corresponding measurement value in the TO path profile is below the threshold.

13. The system of claim 11, wherein:
the configuration information comprises a false alarm threshold; and
the WTRU to determine the at least one false alarm path further determines that a probability of a false alarm for at least one of the candidate object paths and a corresponding EO measurement value in the EO path profile is above the false alarm threshold.

14. The system of claim 11, wherein the configuration information comprises a downlink positioning reference signal (DL-PRS) configuration.

15. The system of claim 14, wherein the WTRU performs the path measurements based on the DL-PRS configuration and received resources of the DL-PRS.

16. The system of claim 14, wherein the DL-PRS configuration indicates to the WTRU to determine and report a false alarm probability of the detected TO.

17. The system of claim 14, wherein resources of the DL-PRS comprise a beam sweeping pattern.

18. The system of claim 11, wherein the path measurements comprise at least one of reference signal received power (RSRP), RSRP per path (RSRPP), delay, relative delay, angle of arrival (AoA), doppler shift, delay spread, doppler spread, reference signal time difference (RSTD), WTRU reception-transmission time difference, reference signal carrier phase (RSCP) measurement, RSCP per path (RSCPP), RSCP difference (RSCPD) measurement, RSCPD measurement per path, radar cross section (RCS), or micro-doppler measurement.

19. The system of claim 11, wherein:
each of the TO path profile and the EO path profile comprises at least one statistic associated with a reference TO measurement value and a reference EO measurement value, respectively; and
the at least one statistic comprises at least one of a mean or a variance.

20. The system of claim 11, wherein:
the WTRU to determine (2) the at least one false alarm path further determines a confidence value associated with the false alarm path; and
the information further indicates the confidence value.
